(19) United States
(12) Patent Application Publication
(10) Pub. No.: US 2024/0240946 A1
(43) Pub. Date: Jul. 18, 2024

(54) INERTIAL SENSOR AND INERTIAL MEASUREMENT UNIT

(71) Applicant: SEIKO EPSON CORPORATION, Tokyo (JP)

(72) Inventors: Shota Kigure, Matsumoto-shi (JP); Teruo Takizawa, Matsumoto-shi (JP)

(21) Appl. No.: 18/414,096

(22) Filed: Jan. 16, 2024

(30) Foreign Application Priority Data
Jan. 18, 2023 (JP) 2023-005673

(51) Int. Cl. G01C 21/16

(52) U.S. Cl. CPC G01C 21/16

(57) ABSTRACT

An inertial sensor includes: a base provided with a mount; a sensor element bonded to the mount; and a wiring electrically coupled to the sensor element. The sensor element includes a first part of a supporter that is bonded to the mount through a bonding part, a suspension including first movable electrode fingers, and a second part of the supporter that is provided between the first part of the supporter and the suspension and that is wider than the suspension. The second part of the supporter is formed with a slit serving as a through hole.

The present application is based on, and claims priority from JP Application Serial Number 2023-005673, filed Jan. 18, 2023, the disclosure of which is hereby incorporated by reference herein in its entirety.

### BACKGROUND

### 1. Technical Field

The present disclosure relates to an inertial sensor and an inertial measurement unit including the inertial sensor.

### 2. Related Art

JP-A-2018-91818 discloses an inertial sensor including a movable part that is swingable with respect to a substrate, a supporter bonded to the substrate and supporting the movable part, and a protrusion provided between the movable part and the supporter, in which the protrusion reduces a bonding stress caused by bonding between the supporter and the substrate.

JP-A-2018-91818 is an example of the related art.

However, even with the inertial sensor disclosed in JP-A-2018-91818, it is difficult to sufficiently reduce the stress, and further improvement in stress reduction is desired.

### SUMMARY

An inertial sensor according to an aspect of the present application includes: a substrate provided with a mount; a sensor element bonded to the mount; and a wiring electrically coupled to the sensor element. The sensor element includes a first coupling part that is bonded to the mount through a bonding part, a second coupling part including electrode fingers, and a third coupling part that is provided between the first coupling part and the second coupling part and that is wider than the second coupling part. The third coupling part is formed with a through hole.

An inertial sensor according to an aspect of the present application includes: a substrate including a first mount and a second mount; a sensor element bonded to the first mount and the second mount; and a wiring electrically coupled to the sensor element. The sensor element includes a first coupling part that is bonded to the first mount through a first bonding part, a second coupling part including electrode fingers, a third coupling part that is provided between the first coupling part and the second coupling part and that is wider than the second coupling part, and a fourth coupling part that is provided between the first coupling part and the second coupling part and that is wider than the second coupling part. The third coupling part has a first through hole. The fourth coupling part is formed with a second through hole.

An inertial measurement unit according to an aspect of the present application includes: the above-described inertial sensor.

### BRIEF DESCRIPTION OF THE DRAWINGS

FIG. 1 is a plan view of an inertial sensor according to Embodiment 1.

FIG. 2 is a cross-sectional view of the inertial sensor taken along a line A-A in FIG. 1.

FIG. 3 is a partially enlarged plan view of the inertial sensor in FIG. 1.

FIG. 4 is a partially enlarged cross-sectional view of the inertial sensor in FIG. 1.

FIG. 5 is a partially enlarged cross-sectional view of the inertial sensor in FIG. 1.

FIG. 6 is a cross-sectional view of an inertial sensor according to a modification.

FIG. 7 is a partially enlarged plan view of the inertial sensor in FIG. 6.

FIG. 8 is a plan view of an inertial sensor according to Embodiment 2.

FIG. 9 is a cross-sectional view of the inertial sensor taken along a line D-D in FIG. 8.

FIG. 10 is a cross-sectional view of the inertial sensor taken along a line E-E in FIG. 8.

FIG. 11 is a partially enlarged plan view of the inertial sensor in FIG. 8.

FIG. 12A is a partially enlarged plan view of the inertial sensor in FIG. 8.

FIG. 12B is a partially enlarged plan view of the inertial sensor in FIG. 8.

FIG. 13 is a plan view of an inertial sensor according to Modification 1.

FIG. 14 is a cross-sectional view of the inertial sensor taken along a line F-F in FIG. 13.

FIG. 15 is a plan view of an inertial sensor according to Modification 2.

FIG. 16 is a cross-sectional view of the inertial sensor taken along a line G-G in FIG. 15.

FIG. 17 is a plan view of an inertial sensor according to Modification 3.

FIG. 18 is a cross-sectional view of the inertial sensor taken along a line H-H in FIG. 17.

FIG. 19 is an exploded perspective view showing a schematic configuration of an inertial measurement unit.

FIG. 20 is a perspective view of a substrate on which an inertial sensor is mounted.

### DESCRIPTION OF EMBODIMENTS

Hereinafter, an embodiment of the present disclosure will be described with reference to the drawings.

In the following drawings, in order to make each component easier to see, the scale of dimensions may be changed depending on the component.

Hereinafter, for convenience of description, three axes orthogonal to one another are referred to as an X axis, a Y axis, and a Z axis, and a direction parallel to the X axis is referred to as an “X-axis direction”, a direction parallel to the Y axis is referred to as a “Y-axis direction”, and a direction parallel to the Z axis is referred to as a “Z-axis direction”. In addition, a tip end side of each axis in an arrow direction is also referred to as a “plus side”, and an opposite side is also referred to as a “minus side”. Hereinafter, viewing in the Z-axis direction is also referred to as a “plan view”, and viewing in the Y-axis direction with respect to a cross section including the Z axis is also referred to as a “cross-sectional view”.

Further, in the following description, for example, for a base, a description “on the base” indicates any one of a case of being disposed in contact with the base, a case of being disposed on the base through another structure, and a case of being disposed on the base partially in contact with the base and partially disposed through another structure. In addition, in a description of an “upper surface” of a certain configuration, a surface on a plus side of the configuration in the Z-axis direction, for example, an “upper surface of a base” indicates a surface on the plus side of the base in the Z-axis direction. In addition, in a description of a “lower surface” of a certain configuration, a surface on a minus side of the configuration in the Z-axis direction, for example, a “lower surface of a lid” indicates a surface on the minus side of the lid in the Z-axis direction.

### 1. Embodiment 1

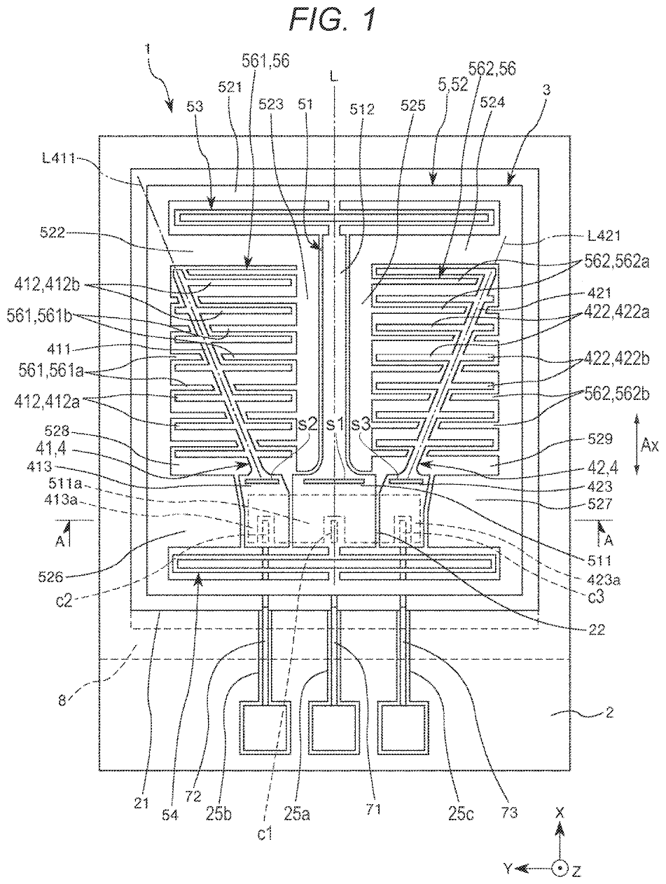

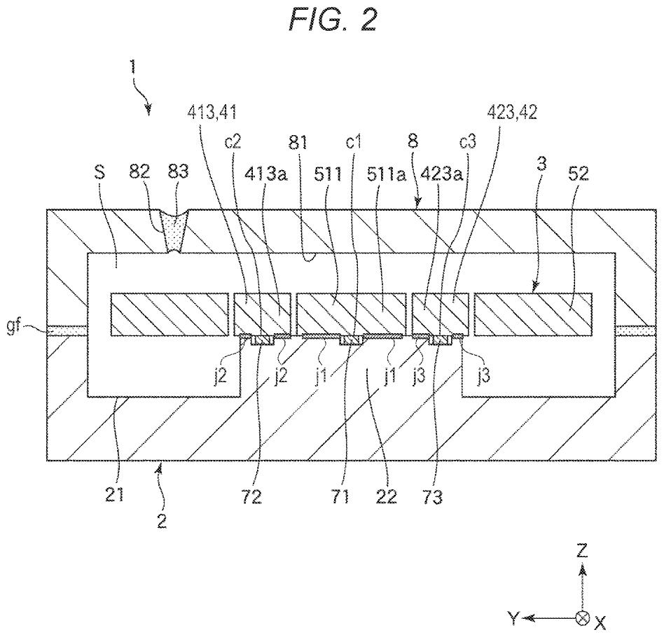

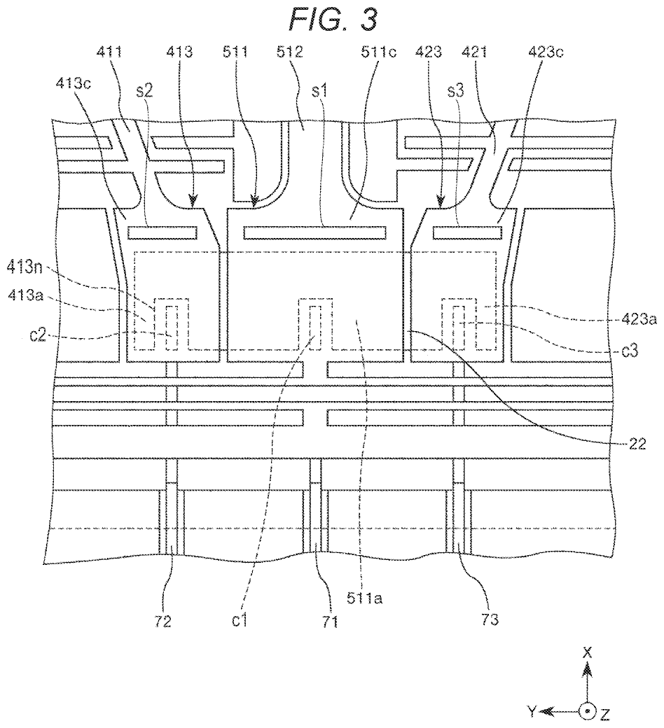

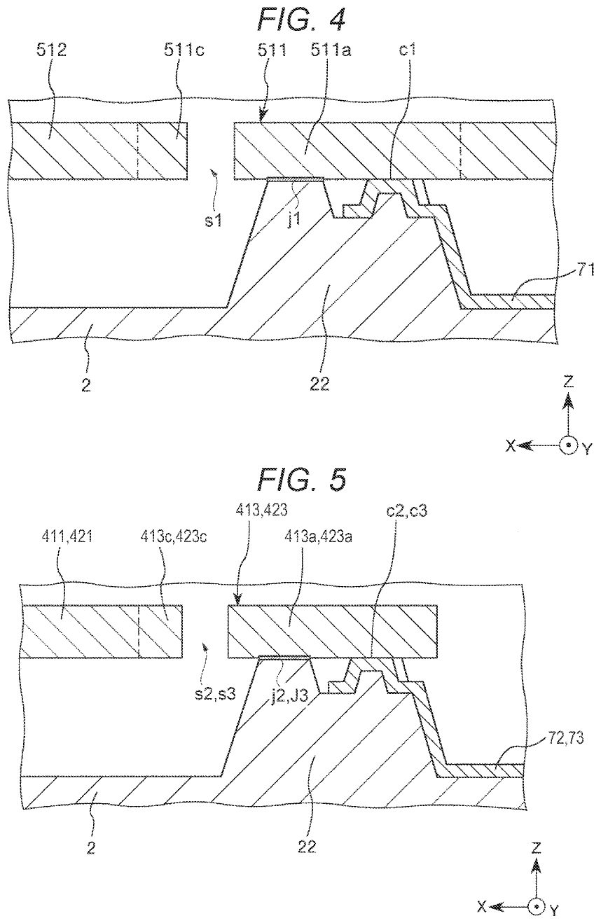

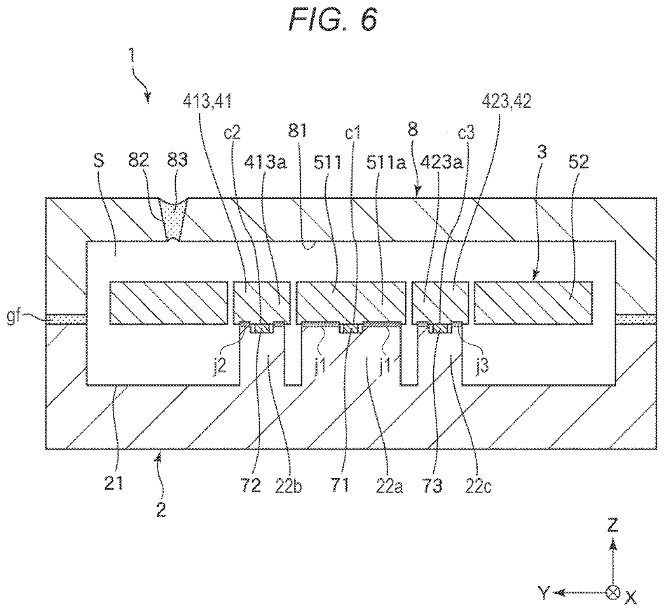

FIG. 1 is a plan view showing an inertial sensor according to Embodiment 1. In FIG. 1, a lid 8 is made transparent for convenience of description. FIG. 2 is a cross-sectional view taken along a line A-A in FIG. 1. FIG. 3 is a partially enlarged plan view of the inertial sensor shown in FIG. 1. FIGS. 4 and 5 are partially enlarged cross-sectional views of the inertial sensor shown in FIG. 1.

An inertial sensor 1 shown in FIG. 1 is an acceleration sensor capable of detecting an acceleration Ax in an X-axis direction. Such an inertial sensor 1 includes a base 2, a sensor element 3 disposed on the base 2, and the lid 8 bonded to the base 2 in a manner of covering the sensor element 3.

Hereinafter, details of the inertial sensor 1 according to Embodiment 1 will be described in the following items.
1.1. Base
1.2. Lid
1.3. Sensor Element
1. Movable Electrode Part
2. Fixed Electrode Part
3. Slit
1.4. Modifications

### 1.1. Base

As shown in FIG. 1, the base 2 has a rectangular shape in a plan view. The base 2 has a recess 21 that is open to an upper surface side. In the plan view, the recess 21 is formed larger than the sensor element 3 to include the sensor element 3 therein. The recess 21 functions as an escape part for preventing contact between the sensor element 3 and the base 2.

As shown in FIG. 2, the base 2 has a protruding mount 22 provided at a bottom surface of the recess 21. Further, the sensor element 3 is bonded to the mount 22.

In addition, as shown in FIG. 1, the base 2 has grooves 25a, 25b, and 25c that open to an upper surface side. In addition, one end of each of the grooves 25a, 25b, and 25c is located outside the lid 8, and the other end is coupled to the recess 21.

As the base 2, for example, a glass material containing alkali metal ions as movable ions, for example, a glass substrate made of borosilicate glass such as Pitex (registered trademark) glass can be used. Accordingly, the base 2 and the lid 8 can be bonded by anodic bonding, and the base 2 and the lid 8 can be firmly bonded. Since the base 2 made of the glass substrate has light transparency, a state of the sensor element 3 can be visually recognized from the outside of the inertial sensor 1 through the base 2.

The base 2 is not limited to the glass substrate. For example, a silicon substrate or a ceramic substrate may be used as the base 2. When a silicon substrate is used, it is preferable to use a silicon substrate having a high resistance or a silicon substrate on which a silicon oxide film, which is an insulating oxide, is formed on a surface by thermal oxidation or the like, from the viewpoint of preventing a short circuit.

As shown in FIG. 1, the grooves 25a, 25b, and 25c are provided with wirings 71, 72, and 73. One end of the wiring 71 in the groove 25a is exposed to the outside of the lid 8, and functions as a terminal for electrical coupling with an external device.

As shown in FIG. 2, the other ends of the wirings 71, 72, 73 are routed through the recess 21 to the mount 22. Further, the wirings 71, 72, and 73 are electrically coupled to the sensor element 3 at contacts c1, c2, and c3 on the mount 22, respectively.

Constituent materials of the wirings 71, 72, and 73 are not particularly limited. Examples thereof include metal materials such as gold (Au), silver (Ag), platinum (Pt), palladium (Pd), iridium (Ir), copper (Cu), aluminum (Al), nickel (Ni), Ti (titanium), and tungsten (W), alloys containing such a metal material, and oxide-based transparent conductive materials such as indium tin oxide (ITO), indium zinc oxide (IZO), zinc oxide (ZnO), and IGZO. In addition, one or more of these materials can be combined to form, for example, a laminate of two or more layers.

### 1.2. Lid

As shown in FIG. 1, the lid 8 has a rectangular shape in a plan view. In addition, as shown in FIG. 2, the lid 8 has a recess 81 on a lower surface side. Further, the lid 8 is bonded to the base 2 so as to store the sensor element 3 in the recess 81. A storage space S for storing the sensor element 3 is formed by the lid 8 and the base 2.

As shown in FIG. 2, the lid 8 has a communication hole 82 that communicates an inside and an outside of the storage space S, and the storage space S can be replaced with a desired atmosphere through the communication hole 82. In addition, a sealing member 83 is disposed in the communication hole 82, and the communication hole 82 is sealed by the sealing member 83.

The sealing member 83 is not particularly limited as long as the sealing member 83 can seal the communication hole 82. For example, various alloys such as gold (Au)/tin (Sn)-based alloys, gold (Au)/germanium (Ge)-based alloys, gold (Au)/aluminum (Al)-based alloys, and glass materials such as low-melting-point glass can be used.

It is preferable that inert gas such as nitrogen, helium, or argon is sealed in the storage space S, and the storage space S is at a use temperature (about −40° C. to 80° C.) and substantially at an atmospheric pressure. By setting the storage space S to the atmospheric pressure, a viscous resistance is increased and a damping effect is exerted, and a vibration of a movable part 52 of the sensor element 3 can be quickly converged or stopped. Therefore, detection accuracy of an acceleration of the inertial sensor 1 serving as an acceleration sensor is improved.

In the embodiment, the lid 8 is formed of the silicon substrate. The lid 8 is not limited to the silicon substrate. For example, a glass substrate or a ceramic substrate may be used as the lid 8.

In addition, a method for bonding the base 2 and the lid 8 is not particularly limited. The method for bonding the base 2 and the lid 8 maybe appropriately selected depending on the materials of the base 2 and the lid 8. Examples thereof include anodic bonding, bonding by bonding surfaces activated by plasma irradiation, bonding using a bonding material such as a glass frit, and diffusion bonding of bonding metal films formed on an upper surface of the base 2 and a lower surface of the lid 8.

In the embodiment, as shown in FIG. 2, the base 2 and the lid 8 are bonded to each other through a glass frit gf made of low-melting-point glass, which is an example of a bonding material. In a state in which the base 2 and the lid 8 are overlapped with each other, the inside and outside of the storage space S communicate with each other through the grooves 25a, 25b, and 25c. By using the glass frit gf, the base 2 and the lid 8 can be bonded together, and the grooves 25a, 25b, and 25c can be sealed, making it easier to hermetically seal the storage space S.

When the base 2 and the lid 8 are bonded by a bonding method such as anodic bonding that does not seal the grooves 25a, 25b, and 25c, the grooves 25a, 25b, 25c can be closed by, for example, a SiO₂ film formed by a CVD method using tetraethoxysilane (TEOS) or the like.

### 1.3. Sensor Element

As shown in FIG. 1, the sensor element 3 includes the fixed electrode part 4 fixed to the base 2 and the movable electrode part 5 fixed to the base 2.

The sensor element 3 can be formed by, for example, patterning a silicon substrate doped with impurities such as phosphorus (P) and boron (B).

In addition, the sensor element 3 is bonded to the mount 22 of the base 2 by anodic bonding. However, the material of the sensor element 3 and the method for bonding the sensor element 3 to the base 2 are not particularly limited.

A thickness of the sensor element 3 is not particularly limited. For example, in the embodiment, the thickness is 20 μm or more and 50 μm or less. Accordingly, the sensor element 3 can be made thin while maintaining sufficient mechanical strength of the sensor element 3. Therefore, the inertial sensor 1 can be reduced in size and height.

### 1.3.1. Movable Electrode Part

The movable electrode part 5 includes a movable part supporter 51, a movable part 52, a spring 53, and a spring 54. The movable part supporter 51, the movable part 52, the spring 53, and the spring 54 are integrally formed and electrically coupled to one another.

The movable part supporter 51 includes a supporter 511 fixed to the mount 22 and a suspension 512 coupled to the supporter 511.

The movable part 52 is displaceable with respect to the movable part supporter 51 in the X-axis direction. In addition, the movable part 52 includes a movable electrode part 56.

The movable electrode part 56 includes a first movable electrode part 561 and a second movable electrode part 562. The first movable electrode part 561 includes first movable electrode fingers 561a and 561b. The second movable electrode part 562 includes second movable electrode fingers 562a and 562b.

The spring 53 and the spring 54 couple the movable part supporter 51 and the movable part 52.

### 1.3.1.1. Movable Part Supporter

As shown in FIG. 1, the movable part supporter 51 includes the supporter 511 and the suspension 512, and is provided between a first fixed electrode part 41 and a second fixed electrode part 42.

The supporter 511 includes a first part 511a.

As shown in FIG. 2, the first part 511a is a part that is bonded to the mount 22 through a bonding part j1 in the supporter 511. The bonding part j1 indicates a part where the first part 511a and the mount 22 are anodically bonded. In the embodiment, the first part 511a corresponds to the first coupling part.

The supporter 511 is electrically coupled to the wiring 71 through the contact c1.

The suspension 512 is located on a plus side of the supporter 511 in the X-axis direction and has an elongated plate shape extending in the X-axis direction. Further, an end of the suspension 512 on a minus side in the X-axis direction is coupled to the supporter 511.

In addition, a width of the suspension 512, that is, a length in the Y-axis direction is smaller than a width of the supporter 511, that is, a length in the Y-axis direction. Accordingly, it is possible to reduce a size of the suspension 512 and increase a mass of the movable part 52 without increasing a size of the movable part 52 located around the suspension 512. Therefore, a physical quantity can be detected more accurately while preventing an increase in the size of the sensor element 3. Hereinafter, in a plan view, a virtual axis bisecting the suspension 512 in the Y-axis direction is taken as a central axis L. In the embodiment, the suspension 512 corresponds to a second coupling part.

### 1.3.1.2. Movable Part

As shown in FIG. 1, the movable part 52 has a frame shape in a plan view, and surrounds the movable part supporter 51, the springs 53 and 54, the first fixed electrode part 41, and the second fixed electrode part 42. In this way, by forming the movable part 52 in the frame shape, it is possible to further increase the mass of the movable part 52 while reducing the size of the movable part 52. Therefore, a physical quantity can be detected more accurately while preventing an increase in the size of the sensor element 3.

The movable part 52 includes a first opening 528 and a second opening 529 arranged side by side in the Y-axis direction. The first fixed electrode part 41 and the first movable electrode part 561 are disposed in the first opening 528, and the second fixed electrode part 42 and the second movable electrode part 562 are disposed in the second opening 529.

The first movable electrode part 561 includes a plurality of first movable electrode fingers 561a and 561b located on both sides of a suspension 411 in the Y-axis direction and extending in the Y-axis direction.

The first movable electrode fingers 561a are located on a plus side of the suspension 411 in the Y-axis direction.

The first movable electrode fingers 561b are located on a minus side of the suspension 411 in the Y-axis direction. In addition, the first movable electrode fingers 561a and 561b are spaced apart from each other along the X-axis direction.

The first movable electrode fingers 561a and 561b are located on the plus side with respect to the corresponding first fixed electrode fingers 412 in the X-axis direction, and face the first fixed electrode fingers 412 with a gap therebetween.

A length of the first movable electrode fingers 561a, that is, a length in the Y-axis direction gradually decreases toward the plus side in the X-axis direction. On the other hand, a length of the plurality of first movable electrode fingers 561b, that is, a length in the Y-axis direction gradually increases toward the plus side in the X-axis direction.

The second movable electrode part 562 includes a plurality of second movable electrode fingers 562a and 562b located on both sides of a suspension 421 in the Y-axis direction and extending in the Y-axis direction.

The second movable electrode fingers 562a are located on a plus side of the suspension 421 in the Y-axis direction.

The second movable electrode fingers 562b are located on a minus side of the suspension 421 in the Y-axis direction. In addition, the second movable electrode fingers 562a and 562b are spaced apart from each other along the X-axis direction.

The second movable electrode fingers 562a and 562b are located on the minus side with respect to the corresponding second fixed electrode fingers 422 in the X-axis direction, and face the second fixed electrode fingers 422 with a gap therebetween.

A length of the plurality of second movable electrode fingers 562a, that is, a length in the Y-axis direction gradually increases toward the plus side in the X-axis direction. On the other hand, a length of the plurality of second movable electrode fingers 562b, that is, a length in the Y-axis direction gradually decreases toward the plus side in the X-axis direction.

The movable part 52 includes a frame 521, a first Y-axis extension 522, a first X-axis extension 523, a second Y-axis extension 524, and a second X-axis extension 525.

The frame 521 surrounds the first fixed electrode part 41 and the second fixed electrode part 42.

The first Y-axis extension 522 is located on the plus side of the first opening 528 in the X-axis direction and extends from the frame 521 toward the minus side in the Y-axis direction.

The first X-axis extension 523 extends from a distal end of the first Y-axis extension 522 toward the minus side in the X-axis direction.

The second Y-axis extension 524 is located on the plus side of the second opening 529 in the X-axis direction and extends from the frame 521 to the plus side in the Y-axis direction.

The second X-axis extension 525 extends from a distal end of the second Y-axis extension 524 toward the minus side in the X-axis direction.

The first Y-axis extension 522 and the second Y-axis extension 524 are each disposed near the spring 53 and along the spring 53, and the first X-axis extension 523 and the second X-axis extension 525 are each located near the movable part supporter 51 and disposed along the movable part supporter 51.

The movable part 52 includes a first protrusion 526 protruding from the frame 521 into the first opening 528 in a manner of filling a remaining space of the first opening 528, and a second protrusion 527 protruding from the frame 521 into the second opening 529 in a manner of filling a remaining space of the second opening 529.

By forming the first protrusion 526 and the second protrusion 527 in this way, it is possible to further increase the mass of the movable part 52 without increasing the size of the movable part 52. Therefore, the inertial sensor 1 with higher sensitivity is obtained.

### 1.3.1.3. Spring

As shown in FIG. 1, the spring 53 couples an end of the movable part 52 on the plus side in the X-axis direction and an end of the movable part supporter 51 on the plus side in the X-axis direction.

The spring 54 couples an end of the movable part 52 on the minus side in the X-axis direction and an end of the movable part supporter 51 on the minus side in the X-axis direction.

The spring 53 and the spring 54 support the movable part 52 on both sides in the X-axis direction. Therefore, a posture and a behavior of the movable part 52 are stabilized, and the acceleration can be detected with higher accuracy.

### 1.3.2. Fixed Electrode Part

The fixed electrode part 4 includes the first fixed electrode part 41 and the second fixed electrode part 42.

The first fixed electrode part 41 is located in the first opening 528, and the second fixed electrode part 42 is located in the second opening 529. In addition, the first fixed electrode part 41 and the second fixed electrode part 42 are line-symmetrically provided with the central axis L as a symmetrical axis.

The first fixed electrode part 41 includes a supporter 413 fixed to the mount 22, the suspension 411 supported by the supporter 413, and a plurality of first fixed electrode fingers 412 extending from the suspension 411 to both sides in the Y-axis direction. The supporter 413, the suspension 411, and the first fixed electrode fingers 412 are integrally formed.

As shown in FIG. 2, the supporter 413 includes a first part 413a. The first part 413a is a part that is coupled to the mount 22 through a bonding part j2 in the supporter 413. The bonding part j2 indicates a part where the first part 413a and the mount 22 are anodically bonded. In the embodiment, the first part 413a corresponds to a first coupling part.

The supporter 413 is electrically coupled to a wiring 72 through the contact c2.

As shown in FIG. 1, the suspension 411 has an elongated rod shape, and one end thereof is coupled to the supporter 413. In addition, a width of the suspension 411, that is, a length in the Y-axis direction is smaller than a width of the supporter 413, that is, a length in the Y-axis direction. In the embodiment, the suspension 411 corresponds to a second coupling part.

The suspension 411 extends in a direction inclined with respect to each of the X axis and the Y axis in a plan view. More specifically, the suspension 411 is inclined such that a separation distance from the central axis L increases toward a distal end side thereof. With such an arrangement, the supporter 413 is easily disposed near the supporter 511. An inclination of the suspension 411 with respect to the X axis is not particularly limited, and is preferably 10° or more and 45° or less, more preferably 10° or more and 30° or less. Accordingly, the first fixed electrode part 41 can be prevented from spreading in the Y-axis direction, and the sensor element 3 can be reduced in size.

The first fixed electrode fingers 412 extend from the suspension 411 to both sides in the Y-axis direction. That is, the first fixed electrode fingers 412 include first fixed electrode fingers 412a located on the plus side of the suspension 411 in the Y-axis direction and first fixed electrode fingers 412b located on the minus side in the Y-axis direction. In addition, the first fixed electrode fingers 412a and 412b are spaced apart from each other along the X-axis direction.

A length of the first fixed electrode fingers 412a, that is, a length in the Y-axis direction gradually decreases toward the plus side in the X-axis direction. On the other hand, a length of the plurality of first fixed electrode fingers 412b, that is, a length in the Y-axis direction gradually increases toward the plus side in the X-axis direction.

The second fixed electrode part 42 includes a supporter 423 fixed to the mount 22, the suspension 421 supported by the supporter 423, and a plurality of second fixed electrode fingers 422 extending from the suspension 421 to both sides in the Y-axis direction. The supporter 423, the suspension 421, and the second fixed electrode fingers 422 are integrally formed.

As shown in FIG. 2, the supporter 423 includes a first part 423a. The first part 423a is a part that is coupled to the mount 22 through a bonding part j3 in the supporter 423. The bonding part j3 indicates a part where the first part 423a and the mount 22 are anodically bonded. In the embodiment, the first part 423a corresponds to a first coupling part.

The supporter 423 is electrically coupled to a wiring 73 through the contact c3.

The suspension 421 has a longitudinal rod shape, and one end thereof is coupled to the supporter 423. In addition, a width of the suspension 421, that is, a length in the Y-axis direction is smaller than a width of the supporter 423, that is, a length in the Y-axis direction. In the embodiment, the suspension 421 corresponds to a second coupling part.

The suspension 421 extends in a direction inclined with respect to each of the X axis and the Y axis in a plan view. More specifically, the suspension 421 is inclined such that a separation distance from the central axis L increases toward a distal end side thereof. With such an arrangement, the supporter 423 is easily disposed near the supporter 511. An inclination of the suspension 421 with respect to the X axis is not particularly limited, and is preferably 10° or more and 45° or less, more preferably 10° or more and 30° or less. Accordingly, the second fixed electrode part 42 can be prevented from spreading in the Y-axis direction, and the sensor element 3 can be reduced in size.

The second fixed electrode fingers 422 extend from the suspension 421 to both sides in the Y-axis direction. That is, the second fixed electrode fingers 422 include second fixed electrode fingers 422a located on the plus side of the suspension 421 in the Y-axis direction and second fixed electrode fingers 422b located on the minus side in the Y-axis direction. In addition, the second fixed electrode fingers 422a and 422b are spaced apart from each other along the X-axis direction.

A length of the plurality of second fixed electrode fingers 422a, that is, a length in the Y-axis direction gradually increases toward the plus side in the X-axis direction. On the other hand, a length of the plurality of second fixed electrode fingers 422b, that is, a length in the Y-axis direction gradually decreases toward the plus side in the X-axis direction.

When the acceleration in the X-axis direction is applied to the sensor element 3, the movable part 52 is displaced in the X-axis direction while elastically deforming the springs 53 and 54 based on a magnitude of the acceleration.

With such a displacement, a gap between the first movable electrode fingers 561a and 561b and the first fixed electrode fingers 412 and a gap between the second movable electrode fingers 562a and 562b and the second fixed electrode fingers 422 change. With the displacement, a static capacitance between the first movable electrode fingers 561a and 561b and the first fixed electrode fingers 412 and a static capacitance between the second movable electrode fingers 562a and 562b and the second fixed electrode fingers 422 change. Then, the acceleration Ax in the X-axis direction can be detected based on the change in the static capacitance.

### 1.3.3. Slit

As shown in FIGS. 4 and 5, each of slits s1, s2, and s3 is a through hole penetrating the sensor element 3. The slits s1, s2, and s3 are formed to reduce influence of stresses such as an external stress or a bonding stress.

As shown in FIG. 3, the slit s1 is formed in the second part 511c of the supporter 511.

The second part 511c is a part of the supporter 511 that does not overlap the bonding part j1 in a plan view. In other words, the second part 511c is a part of the supporter 511 that is not bonded to the mount 22. In the embodiment, the second part 511c corresponds to a third coupling part. That is, the slit s1 is formed in the third coupling part of the supporter 511. The slit s1 is disposed at a position not overlapping the mount 22 in a plan view. The slit s1 may overlap the mount 22 in the plan view.

The slit s2 is formed in the second part 413c of the supporter 413.

The second part 413c is a part of the supporter 413 that does not overlap the bonding part j2 in a plan view. In other words, the second part 413c is a part of the supporter 413 that is not bonded to the mount 22. In the embodiment, the second part 413c corresponds to a third coupling part. That is, the slit s2 is formed in the third coupling part of the supporter 413. The slit s2 is disposed at a position not overlapping the mount 22 in a plan view. The slit s2 may overlap the mount 22 in the plan view.

The slit s3 is formed in the second part 423c of the supporter 423.

The second part 423c is a part of the supporter 423 that does not overlap the bonding part j3 in a plan view. In other words, the second part 423c is a part of the supporter 423 that is not bonded to the mount 22. In the embodiment, the second part 423c corresponds to a third coupling part. That is, the slit s3 is formed in the third coupling part of the supporter 423. The slit s3 is formed at a position not overlapping the mount 22 in a plan view. The slit s3 may overlap the mount 22 in the plan view.

The second part 511c of the supporter 511 is located between the first part 511a and the suspension 512. In the embodiment, the second part 511c is separated from the base 2, and protrudes from the mount 22 in a plan view. The second part 511c may also be referred to as a protrusion.

By forming the slit s1 in the second part 511c, it is possible to reduce the stress such as the external stress and the bonding stress transmitted to the movable part 52 through the bonding part j1 and the first part 511a. Therefore, according to the stress such as the external stress and the bonding stress, measurement accuracy can be prevented from decreasing, and the acceleration Ax can be more accurately detected.

The second part 413c of the supporter 413 is located between the first part 413a and the suspension 411. In the embodiment, the second part 413c is separated from the base 2, and protrudes from the mount 22 in a plan view. The second part 413c may also be referred to as a protrusion.

By forming the slit s2 in the second part 413c, it is possible to reduce the stress such as the external stress and the bonding stress transmitted to the first fixed electrode part 41 through the bonding part j2 and the first part 413a. Therefore, according to the stress such as the external stress and the bonding stress, measurement accuracy can be prevented from decreasing, and the acceleration Ax can be more accurately detected.

The second part 423c of the supporter 423 is located between the first part 423a and the suspension 421. In the embodiment, the second part 423c is separated from the base 2, and protrudes from the mount 22 in a plan view. The second part 423c may also be referred to as a protrusion.

By forming the slit s3 in the second part 423c, it is possible to reduce the stress such as the external stress and the bonding stress transmitted to the second fixed electrode part 42 through the bonding part j3 and the first part 423a. Therefore, according to the stress such as the external stress and the bonding stress, measurement accuracy can be prevented from decreasing, and the acceleration Ax can be more accurately detected.

In this way, since the sensor element 3 has the slits s1, s2, and s3, it is possible to prevent a change in a relative position between the first movable electrode fingers 561a and 561b and the first fixed electrode fingers 412 and a change in a relative position between the second movable electrode fingers 562a and 562b and the second fixed electrode fingers 422 due to the stress such as the external stress and the bonding stress transmitted through the mount 22.

Therefore, it is possible to prevent a change in a static capacitance between the first movable electrode fingers 561a and 561b and the first fixed electrode fingers 412 and a change in a static capacitance between the second movable electrode fingers 562a and 562b and the second fixed electrode fingers 422 in a natural state. Accordingly, the inertial sensor 1 can detect the acceleration Ax with higher accuracy.

### 1.4. Modifications

The above-described embodiment can be variously modified. Hereinafter, specific modifications will be exemplified.

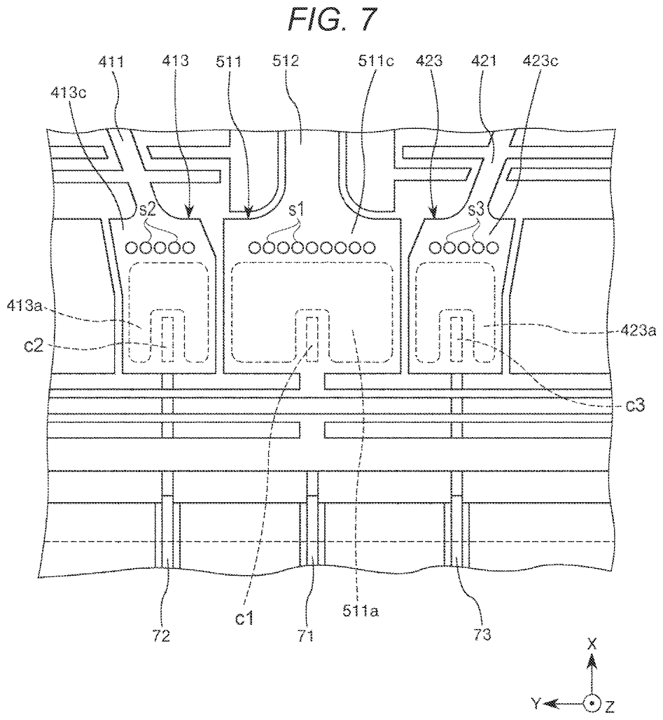

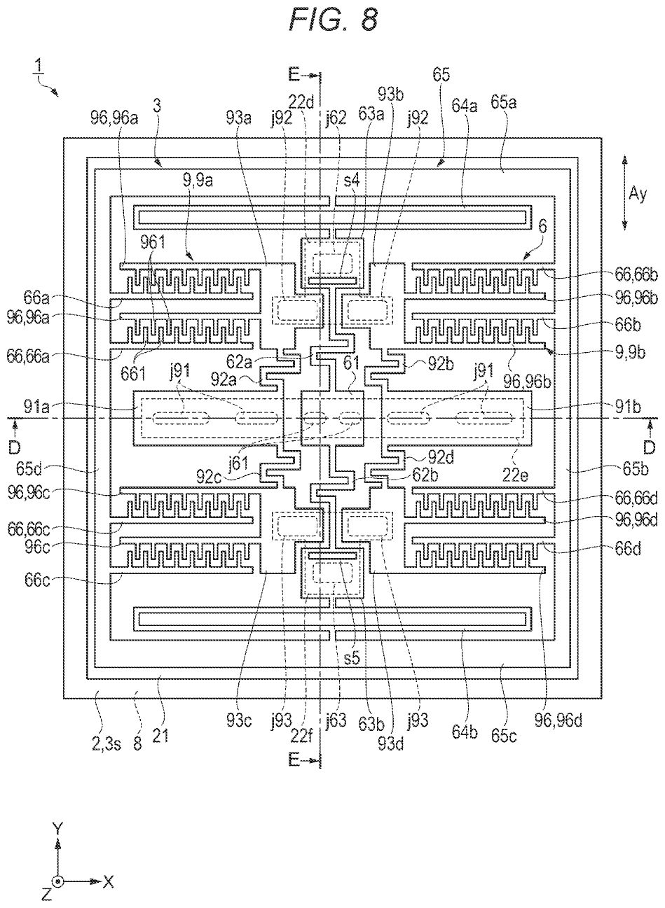

FIG. 6 is a cross-sectional view showing an inertial sensor according to a modification of the embodiment. FIG. 7 is a partially enlarged plan view of the inertial sensor shown in FIG. 6.

In the inertial sensor 1 according to the modification, configurations of the slits s1, s2, s3, the mount 22, and the first parts 511a, 413a, 423a are different from those of the inertial sensor 1 in Embodiment 1. In the following description, differences from Embodiment 1 will be mainly described, and the same components as those in Embodiment 1 are denoted by the same reference signs, and description thereof will be omitted.

As shown in FIG. 6, the base 2 includes three mounts 22a, 22b, and 22c formed in the recess 21. The mounts 22a, 22b, and 22c are obtained by dividing the mount 22 in the above-described Embodiment into three in the Y-axis direction.

The wiring 71 is routed around the mount 22a. In addition, the wiring 72 is routed around the mount 22b. In addition, the wiring 73 is routed around the mount 22c.

The mount 22a is bonded to the supporter 511 through the bonding part j1. In addition, the mount 22b is bonded to the supporter 413 through the bonding part j2. In addition, the mount 22c is bonded to the supporter 423 through the bonding part j3.

As shown in FIG. 7, the second part 511c of the supporter 511 has a plurality of slits s1. In the modification, the slit s1 is a substantially columnar through hole. A shape of the slit s1 may be an elliptical prism, a triangular prism, a square prism, or the like. In addition, the number of the slits s1 is not particularly limited. In addition, the slits s1 may be formed in a plurality of rows along the X-axis direction.

Similarly, the second part 413c of the supporter 413 has a plurality of slits s2. In the modification, the slit s2 is a substantially columnar through hole. A shape of the slit s2 may be an elliptical prism, a triangular prism, a square prism, or the like. In addition, the number of the slits s2 is not particularly limited. In addition, the slits s2 may be formed in a plurality of rows along the X-axis direction.

Similarly, the second part 423c of the supporter 423 has a plurality of slits s3. In the modification, the slit s3 is a substantially columnar through hole. A shape of the slit s3 may be an elliptical prism, a triangular prism, a square prism, or the like. In addition, the number of the slits s3 is not particularly limited. In addition, the slits s3 may be formed in a plurality of rows along the X-axis direction.

The slits s1, s2, and s3 are preferably through holes penetrating the sensor element 3, and may be grooves with a bottom when the slits have a function of reducing the stress such as the external stress or the bonding stress.

The above-described inertial sensor 1 is an acceleration sensor capable of detecting the acceleration Ax in the X-axis direction, and the inertial sensor 1 according to the embodiment can also be applied to an acceleration sensor capable of detecting the acceleration in the Y-axis direction. In addition, the inertial sensor 1 according to the embodiment can also be applied to an acceleration sensor capable of detecting an acceleration in the Z-axis direction. In addition, the inertial sensor 1 according to the embodiment can also be applied to an angular velocity sensor that detects an angular velocity.

As described above, the inertial sensor 1 according to the embodiment includes the base 2 as a substrate provided with the mount 22, the sensor element 3 bonded to the mount 22, and the wiring 71 electrically coupled to the sensor element 3. The sensor element 3 includes the first part 511a of the supporter 511 as a first coupling part bonded to the mount 22 through the bonding part j1, the suspension 512 as a second coupling part including the first movable electrode fingers 561a as electrode fingers, and the second part 511c of the supporter 511 as a third coupling part that is provided between the first part 511a of the supporter 511 and the suspension 512 and that is wider than the suspension 512. The second part 511c of the supporter 511 has the slit s1 as a through hole.

In this way, since the slit s1 is formed in the second part 511c of the supporter 511 that is wider than the suspension 512, it is possible to reduce the influence of the stress transmitted through the bonding part j1, and it is possible to implement the inertial sensor 1 of high quality with little deterioration in detection accuracy.

The inertial sensor 1 according to the embodiment includes the base 2 as a substrate provided with the mount 22, the sensor element 3 bonded to the mount 22, and the wiring 72 or the wiring 73 electrically coupled to the sensor element 3. The sensor element 3 includes the first part 413a of the supporter 413 or the first part 423a of the supporter 423 as a first coupling part that is bonded to the mount 22 through the bonding part j2 or the bonding part j3, the suspension 411 or the suspension 421 as a second coupling part including the first fixed electrode fingers 412 or the second fixed electrode fingers 422 as electrode fingers, and the second part 413c of the supporter 413 or the second part 423c of the supporter 423 as a third coupling part that is provided between the first part 413a of the supporter 413 and the suspension 411 or between the first part 423a of the supporter 423 and the suspension 421 and that is wider than the suspension 411 or the suspension 421. The second part 413c of the supporter 413 or the second part 423c of the supporter 423 has the slit s2 or the slit s3 as a through hole.

In this way, since the slit s2 is formed in the second part 413c of the supporter 413 that is wider than the suspension 411, it is possible to reduce the influence of the stress transmitted through the bonding part j2, and it is possible to implement the inertial sensor 1 of high quality with little deterioration in detection accuracy. Alternatively, since the slit s3 is formed in the second part 423c of the supporter 423 that is wider than the suspension 421, it is possible to reduce the influence of the stress transmitted through the bonding part j3, and it is possible to implement the inertial sensor 1 of high quality with little deterioration in detection accuracy.

In the inertial sensor 1 according to the embodiment, the second part 511c of the supporter 511 serving as the third coupling part further has a plurality of slits s1 as through holes.

In this way, since there are the plurality of slits s1, the influence of the stress transmitted through the bonding part j1 can be dispersed and reduced by the plurality of slits s1, and it is possible to implement the inertial sensor 1 of high quality with little deterioration in detection accuracy.

In the inertial sensor 1 according to the embodiment, the second part 413c of the supporter 413 serving as the third coupling part further has a plurality of slits s2 as through holes. Alternatively, the second part 423c of the supporter 423 serving as the third coupling part further has a plurality of slits s3 as through holes.

In this way, since there are the plurality of slits s2 or s3, the influence of the stress transmitted through the bonding part j2 or the bonding part j3 can be dispersed and reduced by the plurality of slits s2 or the plurality of slits s3, and it is possible to implement the inertial sensor 1 of high quality with little deterioration in detection accuracy.

In the inertial sensor 1 according to the embodiment, the slit s1 serving as the through hole is not bonded to the mount 22 in a plan view.

In this way, the slit s1 is not bonded to the mount 22 in a plan view. In other words, the second part 511c of the supporter 511 having the slit s1 is not bonded to the mount 22. Therefore, it is possible to reduce the influence of the stress transmitted through the bonding part j1, and it is possible to implement the inertial sensor 1 of high quality with little deterioration in detection accuracy.

In the inertial sensor 1 according to the embodiment, the slit s2 or the slit s3 serving as the through hole is not bonded to the mount 22 in a plan view.

In this way, the slit s2 or the slit s3 is not bonded to the mount 22 in a plan view. In other words, the second part 413c of the supporter 413 having the slit s2 and the second part 423c of the supporter 423 having the slit s3 are not bonded to the mount 22. Therefore, it is possible to reduce the influence of the stress transmitted through the bonding part j2 or the bonding part j3, and it is possible to implement the inertial sensor 1 of high quality with little deterioration in detection accuracy.

### 2. Embodiment 2

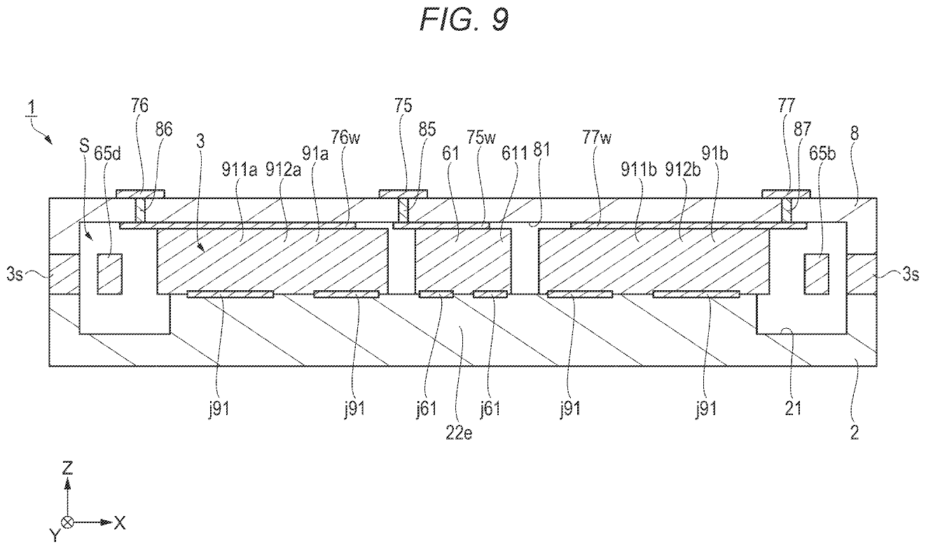

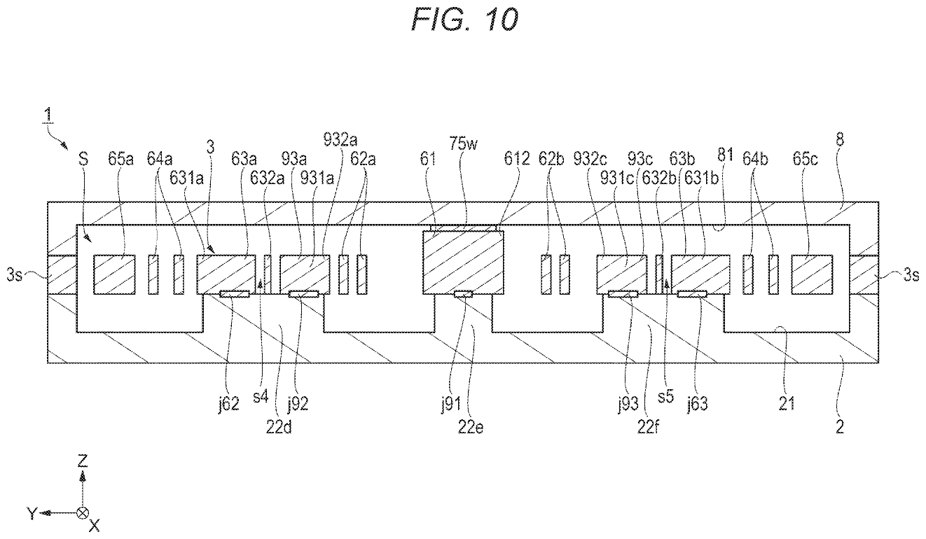

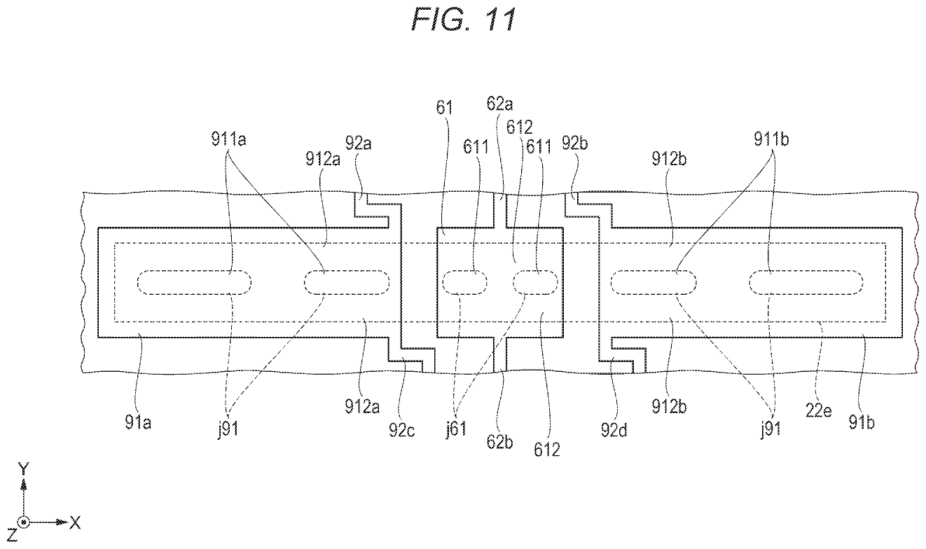

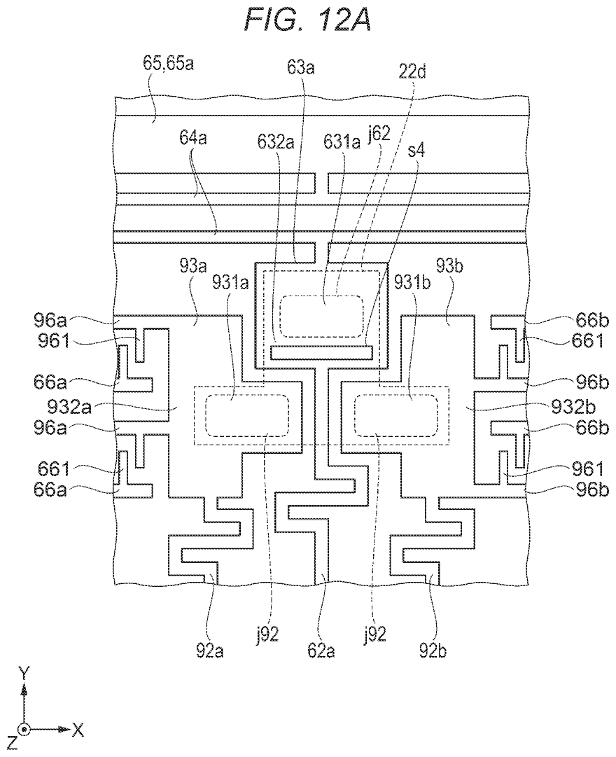

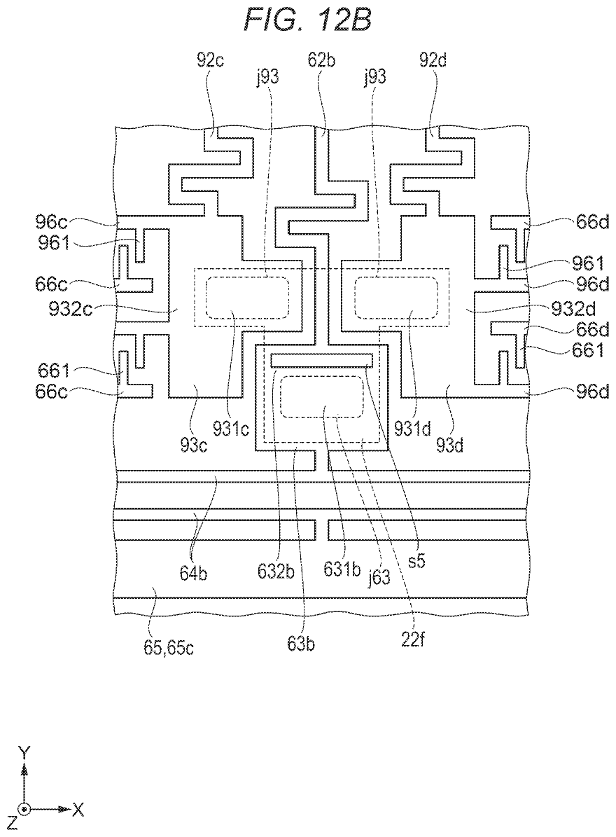

FIG. 8 is a plan view showing an inertial sensor according to Embodiment 2. In FIG. 8, the lid 8 is made transparent for convenience of description. FIG. 9 is a cross-sectional view taken along a line D-D in FIG. 8. FIG. 10 is a cross-sectional view taken along a line E-E in FIG. 8. FIGS. 11, 12A, and 12B are partially enlarged plan views of the inertial sensor shown in FIG. 8. In Embodiment 2, the same components as those of Embodiment 1 are denoted by the same reference signs, and the description thereof may be omitted.

An inertial sensor 1 shown in FIG. 1 is an acceleration sensor capable of detecting an acceleration Ay in a Y-axis direction. Such an inertial sensor 1 includes a base 2, a sensor element 3 disposed on the base 2, and the lid 8 bonded to the base 2 in a manner of covering the sensor element 3.

Hereinafter, details of the inertial sensor 1 according to Embodiment 2 will be described in the following items.
2.1. Base
2.2. Lid
2.3. Sensor Element
1. Movable Electrode Part
2. Fixed Electrode Part
3. Slit
2.4. Modifications
1. Modification 1
2. Modification 2
3. Modification 3

### 2.1. Base

As shown in FIG. 8, the base 2 has a rectangular shape in a plan view. The base 2 has a recess 21 that is open to an upper surface side. In the plan view, the recess 21 is formed larger than the sensor element 3 to include the sensor element 3 therein. The recess 21 functions as an escape part for preventing contact between the sensor element 3 and the base 2.

As shown in FIG. 10, the base 2 includes protruding mounts 22d, 22e, and 22f provided at a bottom surface of the recess 21 along the Y-axis direction. Further, the sensor element 3 is bonded to the mounts 22d, 22e, and 22f.

In addition, a semiconductor layer 3s is provided at an upper surface of a periphery of the base 2 through an insulating layer (not shown). The semiconductor layer 3s is a part of a silicon substrate attached to the base 2 through the insulating layer. The silicon substrate is doped with an impurity such as phosphorus (P) or boron (B). The semiconductor layer 3s and the sensor element 3 are formed by patterning the silicon substrate. The silicon substrate is attached to the base 2 through the insulating layer to form a silicon on insulator (SOI) substrate.

As shown in FIG. 8, the mount 22e is provided at the center in the Y-axis direction in a manner of extending along the X-axis direction, and a conductor 61, a conductor 91a, and a conductor 91b of the sensor element 3 are bonded to an upper surface of the mount 22e.

A mount 22d is provided at the center in the X-axis direction on the plus side of the mount 22e in the Y-axis direction, and a supporter 63a, a supporter 93a, and a supporter 93b of the sensor element 3 are bonded to an upper surface of the mount 22d.

The mount 22f is provided at the center in the X-axis direction on a minus side of the mount 22e in the Y-axis direction, and a supporter 63b, a supporter 93c, and a supporter 93d of the sensor element 3 are bonded to an upper surface of the mount 22f.

In the embodiment, a silicon substrate is used as the base 2. The base 2 maybe a glass substrate or a ceramic substrate.

### 2.2. Lid

As shown in FIG. 8, the lid 8 has a rectangular shape in a plan view.

As shown in FIG. 9, the lid 8 is bonded to the semiconductor layer 3s. The lid 8 has the recess 81 that is opened to a lower surface side. A movable electrode part 6 and a fixed electrode part 9 of the sensor element 3 are accommodated in a storage space S surrounded by the recess 81 of the lid 8, the semiconductor layer 3s, and the recess 21 of the base 2.

In the embodiment, a glass substrate is used as the lid 8. The lid 8 maybe a silicon substrate or a ceramic substrate.

In addition, a method for bonding the lid 8 and the semiconductor layer 3s is not particularly limited. The method for bonding the base 2 and the semiconductor layer 3s may be appropriately selected depending on a material of the lid 8. In the embodiment, the base 2 and the semiconductor layer 3s are bonded to each other via a glass frit made of low-melting-point glass, which is an example of a bonding material.

A terminal 75, a terminal 76, and a terminal 77 for external coupling are provided at an upper surface of the lid 8. In addition, a wiring 75w, a wiring 76w, and a wiring 77w are provided at a lower surface of the lid 8.

The terminal 75 is electrically coupled to the wiring 75w through a conductive member 85 penetrating the lid 8.

The terminal 76 is electrically coupled to the wiring 76w through a conductive member 86 penetrating the lid 8.

The terminal 77 is electrically coupled to the wiring 77w through a conductive member 87 penetrating the lid 8.

The wiring 75w is in contact with the conductor 61 of the sensor element 3 and is electrically coupled to the conductor 61.

The wiring 76w is in contact with the conductor 91a of the sensor element 3 and is electrically coupled to the conductor 91a.

The wiring 77w is in contact with the conductor 91b of the sensor element 3 and is electrically coupled to the conductor 91b.

In the embodiment, a thickness of the conductor 61 of the sensor element 3 is increased and the conductor 61 protrudes toward the lid 8, so that the conductor 61 is brought into contact with the wiring 75w. However, the present disclosure is not limited thereto. A configuration may also be adopted in which a protrusion protruding toward the conductor 61 is provided at the lid 8, and the wiring 75w is routed around a lower surface of the protrusion to bring the wiring 75w and the conductor 61 into contact.

In addition, in the embodiment, a thickness of the conductor 91a of the sensor element 3 is increased and the conductor 91a protrudes toward the lid 8, so that the conductor 91a is brought into contact with the wiring 76w. However, the present disclosure is not limited thereto. A configuration may also be adopted in which a protrusion protruding toward the conductor 91a is provided at the lid 8, and the wiring 76w is routed around a lower surface of the protrusion to bring the wiring 76w and the conductor 91a into contact.

In addition, in the embodiment, a thickness of the conductor 91b of the sensor element 3 is increased and the conductor 91b protrudes toward the lid 8, so that the conductor 91b is brought into contact with the wiring 77w. However, the present disclosure is not limited thereto. A configuration may also be adopted in which a protrusion protruding toward the conductor 91b is provided at the lid 8, and the wiring 77w is routed around a lower surface of the protrusion to bring the wiring 77w and the conductor 91b into contact.

### 2.3. Sensor Element

As shown in FIG. 8, the sensor element 3 includes the movable electrode part 6 fixed to the base 2 and the fixed electrode part 9 fixed to the base 2.

The sensor element 3 is bonded to the mounts 22d, 22e, and 22f of the base 2 by anodic bonding. However, the material of the sensor element 3 and the method for bonding the sensor element 3 to the base 2 are not particularly limited.

### 2.3.1. Movable Electrode Part

The movable electrode part 6 includes the conductor 61, wirings 62a and 62b, the supporters 63a and 63b, springs 64a and 64b, the movable part 65, and a movable electrode 66. The movable electrode 66 includes movable electrodes 66a, 66b, 66c, and 66d, and each of the movable electrodes 66a, 66b, 66c, and 66d includes electrode fingers 661 having a comb tooth shape. The conductor 61, the wirings 62a and 62b, the supporters 63a and 63b, the springs 64a and 64b, the movable part 65, and the movable electrodes 66a, 66b, 66c, and 66d are integrally formed and electrically coupled.

### 2.3.1.1. Conductor

As shown in FIG. 9, the conductor 61 is formed thicker than other structures of the movable electrode part 6 when patterning the silicon substrate, and has a structure in which an upper surface side of the conductor 61 protrudes toward the lid 8.

The upper surface side of the conductor 61 is in contact with the wiring 75w of the lid 8 and is electrically coupled to the terminal 75. A lower surface side of the conductor 61 is bonded to the mount 22e of the base 2 through bonding parts j61. The bonding part j61 indicates a part where the sensor element 3 and the base 2 are anodically bonded.

As shown in FIG. 11, the conductor 61 includes, in a plan view, a first part 611 overlapping the bonding part j61 and a second part 612 not overlapping the bonding part j61. In other words, the first part 611 is a part directly bonded to the mount 22e, and the second part 612 is a part not directly bonded to the mount 22e. In the embodiment, the first part 611 corresponds to the first coupling part, and the second part 612 corresponds to the third coupling part.

### 2.3.1.2. Supporter

As shown in FIG. 10, the supporter 63a is bonded to the mount 22d of the base 2 through a bonding part j62. The bonding part j62 indicates a part where the sensor element 3 and the base 2 are anodically bonded.

As shown in FIG. 12A, the supporter 63a includes, in a plan view, a first part 631a overlapping the bonding part j62 and a second part 632a not overlapping the bonding part j62. In other words, the first part 631a of the supporter 63a is a part directly bonded to the mount 22d, and the second part 632a of the supporter 63a is a part not directly bonded to the mount 22d. In the embodiment, the second part 632a of the supporter 63a corresponds to the third coupling part.

As shown in FIG. 10, the supporter 63b is bonded to the mount 22f of the base 2 through a bonding part j63. The bonding part j63 indicates a part where the sensor element 3 and the base 2 are anodically bonded.

As shown in FIG. 12B, the supporter 63b includes, in a plan view, a first part 631b overlapping the bonding part j63 and a second part 632b not overlapping the bonding part j63. In other words, the first part 631b of the supporter 63b is a part directly bonded to the mount 22f, and the second part 632b of the supporter 63b is a part not directly bonded to the mount 22f. In the embodiment, the second part 632b of the supporter 63b corresponds to the third coupling part.

### 2.3.1.3. Wiring

As shown in FIG. 8, the wiring 62a is provided between the conductor 61 and the supporter 63a. A width of the wiring 62a is smaller than a width of the second part 612 of the conductor 61 or the second part 632a of the supporter 63a, that is, a length in the X-axis direction. Accordingly, a reduction in size of the wiring 62a can be achieved. The wiring 62a functions as a spring.

The wiring 62b is provided between the conductor 61 and the supporter 63b. A width of the wiring 62b is smaller than a width of the second part 612 of the conductor 61 or the second part 632b of the supporter 63b, that is, a length in the X-axis direction. Accordingly, a reduction in size of the wiring 62b can be achieved. In addition, the wiring 62b functions as a spring.

### 2.3.1.4. Movable Part

As shown in FIG. 8, the movable part 65 has a frame shape in a plan view, and includes a Y-axis extension 65a, an X-axis extension 65b, a Y-axis extension 65c, and an X-axis extension 65d.

The movable part 65 is swingable in the Y-axis direction by a spring 64a provided between the Y-axis extension 65a and the supporter 63a and a spring 64b provided between the Y-axis extension 65c and the supporter 63b. Widths of the springs 64a and 64b are substantially equal to or less than those of the wirings 62a and 62b.

A movable electrode 66b and a movable electrode 66d are provided at the X-axis extension 65b of the movable part 65. A plurality of movable electrodes 66b and a plurality of movable electrodes 66d are provided. Each of the movable electrodes 66b and 66d includes the electrode fingers 661 having a comb tooth shape.

A movable electrode 66a and a movable electrode 66c are provided at the X-axis extension 65d of the movable part 65. A plurality of movable electrodes 66a and a plurality of movable electrodes 66c are provided. Each of the movable electrodes 66a and 66c includes the electrode fingers 661 having a comb tooth shape.

The movable electrodes 66a, 66b, 66c, and 66d are each provided with the electrode fingers 661. The widths of the movable electrodes 66a, 66b, 66c, and 66d are equal to or less than those of the wirings 62a and 62b.

### 2.3.2. Fixed Electrode Part

As shown in FIG. 8, the fixed electrode part 9 includes a first fixed electrode part 9a provided on a minus side of the conductor 61 in the X-axis direction, and a second fixed electrode part 9b provided on a plus side of the conductor 61 in the X-axis direction.

### 2.3.2.1. First Fixed Electrode Part

The first fixed electrode part 9a includes the conductor 91a, wirings 92a and 92c, the supporters 93a and 93c, and a fixed electrode 96. The fixed electrode 96 includes fixed electrodes 96a and 96c, and each of the fixed electrodes 96a and 96c includes electrode fingers 961 having a comb tooth shape. The conductor 91a, the wirings 92a and 92c, the supporters 93a and 93c, and the fixed electrodes 96a and 96c are integrally formed and electrically coupled.

### 2.3.2.1.1. Conductor

As shown in FIG. 9, when the silicon substrate including the semiconductor layer 3s is patterned, the conductor 91a is formed thicker than other structures of the first fixed electrode part 9a, and has a structure in which an upper surface side of the conductor 91a protrudes toward the lid 8.

The upper surface side of the conductor 91a is in contact with the wiring 76w of the lid 8 and is electrically coupled to the terminal 76. A lower surface side of the conductor 91a is bonded to the mount 22e of the base 2 through bonding parts j91. The bonding part j91 indicates a part where the sensor element 3 and the base 2 are anodically bonded.

As shown in FIG. 11, the conductor 91a includes, in a plan view, first parts 911a overlapping the bonding parts j91 and a second part 912a not overlapping the bonding parts j91. In other words, the first part 911a is a part directly bonded to the mount 22e, and the second part 912a is a part not directly bonded to the mount 22e. In the embodiment, the first part 911a corresponds to the first coupling part, and the second part 912a corresponds to the third coupling part.

### 2.3.2.1.2. Supporter

As shown in FIG. 10, the supporter 93a is bonded to the mount 22d of the base 2 through a bonding part j92. The bonding part j92 indicates a part where the sensor element 3 and the base 2 are anodically bonded.

As shown in FIG. 12A, the supporter 93a includes, in a plan view, a first part 931a overlapping the bonding part j92 and a second part 932a not overlapping the bonding part j92. In other words, the first part 931a of the supporter 93a is a part directly bonded to the mount 22d, and the second part 932a of the supporter 93a is a part not directly bonded to the mount 22d. In the embodiment, the second part 932a of the supporter 93a corresponds to the third coupling part.

The second part 932a of the supporter 93a is located between the first part 931a and the fixed electrode 96a. In addition, the second part 932a of the supporter 93a is located between the first part 931a and the wiring 92a. In the embodiment, the second part 932a is separated from the base 2, and protrudes from the mount 22d in a plan view. The second part 932a may also be referred to as a protrusion.

As shown in FIG. 10, the supporter 93c is bonded to the mount 22f of the base 2 through a bonding part j93. The bonding part j93 indicates a part where the sensor element 3 and the base 2 are anodically bonded.

As shown in FIG. 12B, the supporter 93c includes, in a plan view, a first part 931c overlapping the bonding part j93 and a second part 932c not overlapping the bonding part j93. In other words, the first part 931c of the supporter 93c is a part directly bonded to the mount 22f, and the second part 932c of the supporter 93c is a part not directly bonded to the mount 22f. In the embodiment, the second part 932c of the supporter 93c corresponds to the third coupling part.

The second part 932c of the supporter 93c is located between the first part 931c and the fixed electrode 96c. In addition, the second part 932c of the supporter 93c is located between the first part 931c and the wiring 92c. In the embodiment, the second part 932c is separated from the base 2, and protrudes from the mount 22f in a plan view. The second part 932c may also be referred to as a protrusion.

### 2.3.2.1.3. Fixed Electrode

As shown in FIG. 8, the fixed electrode 96a extends from the supporter 93a to the minus side in the X-axis direction. The fixed electrode 96a includes the electrode fingers 961 having a comb tooth shape, and faces the electrode fingers 661 of the movable electrode 66a. A width of the fixed electrode 96a is substantially equal to a width of the movable electrode 66a.

The fixed electrode 96c extends from the supporter 93c to the minus side in the X-axis direction. The fixed electrode 96c includes the electrode fingers 961 having a comb tooth shape, and faces the electrode fingers 661 of the movable electrode 66c. A width of the fixed electrode 96c is substantially equal to a width of the movable electrode 66c.

### 2.3.2.1.4. Wiring

As shown in FIG. 8, the wiring 92a is provided between the conductor 91a and the supporter 93a. A width of the wiring 92a is smaller than a width of the second part 912a of the conductor 91a or the second part 932a of the supporter 93a, that is, a length in the X-axis direction. Accordingly, a reduction in size of the wiring 92a can be achieved. The wiring 92a functions as a spring.

The wiring 92c is provided between the conductor 91a and the supporter 93c. A width of the wiring 92c is smaller than a width of the second part 912a of the conductor 91a or the second part 932c of the supporter 93c, that is, a length in the X-axis direction. Accordingly, a reduction in size of the wiring 92c can be achieved. The wiring 92c functions as a spring.

### 2.3.2.2. Second Fixed Electrode Part

The second fixed electrode part 9b includes the conductor 91b, wirings 92b and 92d, the supporters 93b and 93d, and the fixed electrode 96. The fixed electrode 96 includes fixed electrodes 96b and 96d, and each of the fixed electrodes 96b and 96d includes the electrode fingers 961 having a comb tooth shape. The conductor 91b, the wirings 92b and 92d, the supporters 93b and 93d, and the fixed electrodes 96b and 96d are integrally formed and electrically coupled.

### 2.3.2.2.1. Conductor

As shown in FIG. 9, when the silicon substrate including the semiconductor layer 3s is patterned, the conductor 91b is formed thicker than other structures of the second fixed electrode part 9b, and has a structure in which an upper surface side of the conductor 91b protrudes toward the lid 8.

The upper surface side of the conductor 91b is in contact with the wiring 77w of the lid 8 and is electrically coupled to the terminal 77. A lower surface side of the conductor 91b is bonded to the mount 22e of the base 2 through bonding parts j91.

As shown in FIG. 11, the conductor 91b includes, in a plan view, a first part 911b overlapping the bonding part j91 and a second part 912b not overlapping the bonding part j91. In other words, the first part 911b is a part directly bonded to the mount 22e, and the second part 912b is a part not directly bonded to the mount 22e. In the embodiment, the first part 911b corresponds to the first coupling part, and the second part 912b corresponds to the third coupling part.

### 2.3.2.2.2. Supporter

The supporter 93b is bonded to the mount 22d of the base 2 through the bonding part j92.

As shown in FIG. 12A, the supporter 93b includes, in a plan view, a first part 931b overlapping the bonding part j92 and a second part 932b not overlapping the bonding part j92. In other words, the first part 931b of the supporter 93b is a part directly bonded to the mount 22d, and the second part 932b of the supporter 93b is a part not directly bonded to the mount 22d. In the embodiment, the second part 932b of the supporter 93b corresponds to the third coupling part.

The second part 932b of the supporter 93b is located between the first part 931b and the fixed electrode 96b. In addition, the second part 932b of the supporter 93b is located between the first part 931b and the wiring 92b. In the embodiment, the second part 932b is separated from the base 2, and protrudes from the mount 22d in a plan view. The second part 932b may also be referred to as a protrusion.

The supporter 93d is bonded to the mount 22f of the base 2 through the bonding part j93.

As shown in FIG. 12B, the supporter 93d includes, in a plan view, a first part 931d overlapping the bonding part j93 and a second part 932d not overlapping the bonding part j93. In other words, the first part 931d of the supporter 93d is a part directly bonded to the mount 22f, and the second part 932d of the supporter 93d is a part not directly bonded to the mount 22f. In the embodiment, the second part 932d of the supporter 93d corresponds to the third coupling part.

The second part 932d of the supporter 93d is located between the first part 931d and the fixed electrode 96d. The second part 932d of the supporter 93d is located between the first part 931d and the wiring 92d. In the embodiment, the second part 932d is separated from the base 2, and protrudes from the mount 22f in a plan view. The second part 932d may also be referred to as a protrusion.

### 2.3.2.2.3. Fixed Electrode

As shown in FIG. 8, the fixed electrode 96b extends from the supporter 93b to the plus side in the X-axis direction. The fixed electrode 96b includes the electrode fingers 961 having a comb tooth shape, and faces the electrode fingers 661 of the movable electrode 66b. A width of the fixed electrode 96b is substantially equal to a width of the movable electrode 66b.

The fixed electrode 96d extends from the supporter 93d to the plus side in the X-axis direction. The fixed electrode 96d includes the electrode fingers 961 having a comb tooth shape, and faces the electrode fingers 661 of the movable electrode 66d. A width of the fixed electrode 96d is substantially equal to a width of the movable electrode 66d.

### 2.3.2.2.4. Wiring

As shown in FIG. 8, the wiring 92b is provided between the conductor 91b and the supporter 93b. A width of the wiring 92b is smaller than a width of the second part 912b of the conductor 91b or the second part 932b of the supporter 93b, that is, a length in the X-axis direction. Accordingly, a reduction in size of the wiring 92b can be achieved. In addition, the wiring 92b functions as a spring.

The wiring 92d is provided between the conductor 91b and the supporter 93d. A width of the wiring 92d is smaller than a width of the second part 912b of the conductor 91b or the second part 932d of the supporter 93d, that is, a length in the X-axis direction. Accordingly, a reduction in size of the wiring 92d can be achieved. In addition, the wiring 92d functions as a spring.

When the acceleration in the Y-axis direction is applied to the sensor element 3, the movable part 65 is displaced in the Y-axis direction while elastically deforming the springs 64a and 64b based on a magnitude of the acceleration.

According to such a displacement, gaps between the movable electrode 66a and the fixed electrode 96a, between the movable electrode 66b and the fixed electrode 96b, between the movable electrode 66c and the fixed electrode 96c, and between the movable electrode 66d and the fixed electrode 96d change. According to the displacement, magnitudes of static capacitance between the movable electrode 66a and the fixed electrode 96a, between the movable electrode 66b and the fixed electrode 96b, between the movable electrode 66c and the fixed electrode 96c, and between the movable electrode 66d and the fixed electrode 96d change. Then, the acceleration Ay in the Y-axis direction can be detected based on the change in the static capacitance.

### 2.3.3. Slit

As shown in FIG. 10, slits s4 and s5 are through holes penetrating the sensor element 3. The slits s4 and s5 are formed to reduce influence of stresses such as an external stress or a bonding stress.

As shown in FIG. 12A, the slit s4 is formed in the second part 632a of the supporter 63a. In other words, the slit s4 is formed in a part of the supporter 63a that is not bonded to the mount 22d.

By forming the slit s4, the stress such as the external stress or the bonding stress transmitted to the movable part 65 through the bonding part j61, the bonding part j62, or the lid 8 and the conductive member 85 can be reduced, and the acceleration Ay can be detected with higher accuracy.

As shown in FIG. 12B, the slit s5 is formed in the second part 632b of the supporter 63b. In other words, the slit s5 is formed in a part of the supporter 63b that is not bonded to the mount 22f.

By forming the slit s5, the stress such as the external stress or the bonding stress transmitted to the movable part 65 through the bonding part j61, the bonding part j63, the lid 8, and the conductive member 85 can be reduced, and the acceleration Ay can be detected with higher accuracy.

In this way, since the sensor element 3 has the slits s4 and s5, it is possible to prevent changes in relative positions between the movable electrode 66a and the fixed electrode 96a, between the movable electrode 66b and the fixed electrode 96b, between the movable electrode 66c and the fixed electrode 96c, and between the movable electrode 66d and the fixed electrode 96d due to the stress such as the external stress or the bonding stress transmitted through the mount 22e, the mount 22d, the mount 22f, the lid 8, and the conductive member 85.

Therefore, it is possible to prevent the change in the static capacitance between the movable electrode 66a and the fixed electrode 96a, between the movable electrode 66b and the fixed electrode 96b, between the movable electrode 66c and the fixed electrode 96c, and between the movable electrode 66d and the fixed electrode 96d in a natural state. Accordingly, the inertial sensor 1 can detect the acceleration Ay with higher accuracy.

### 2.4. Modifications

The above-described embodiment can be variously modified. Hereinafter, specific modifications will be exemplified.

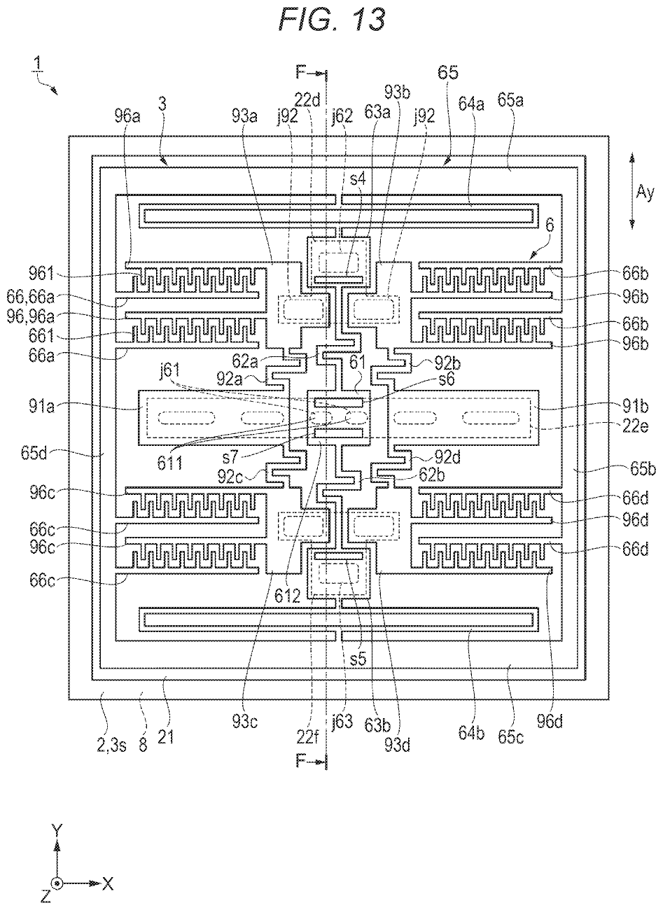

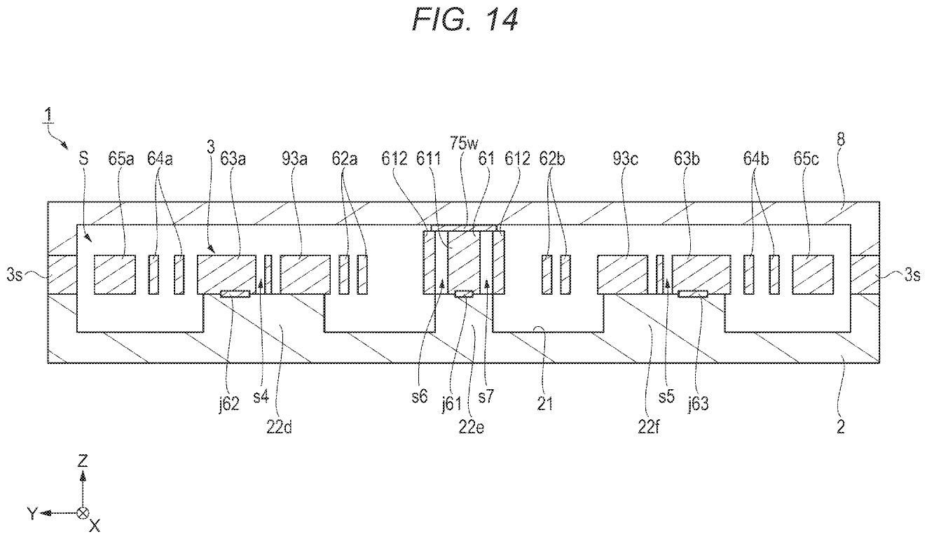

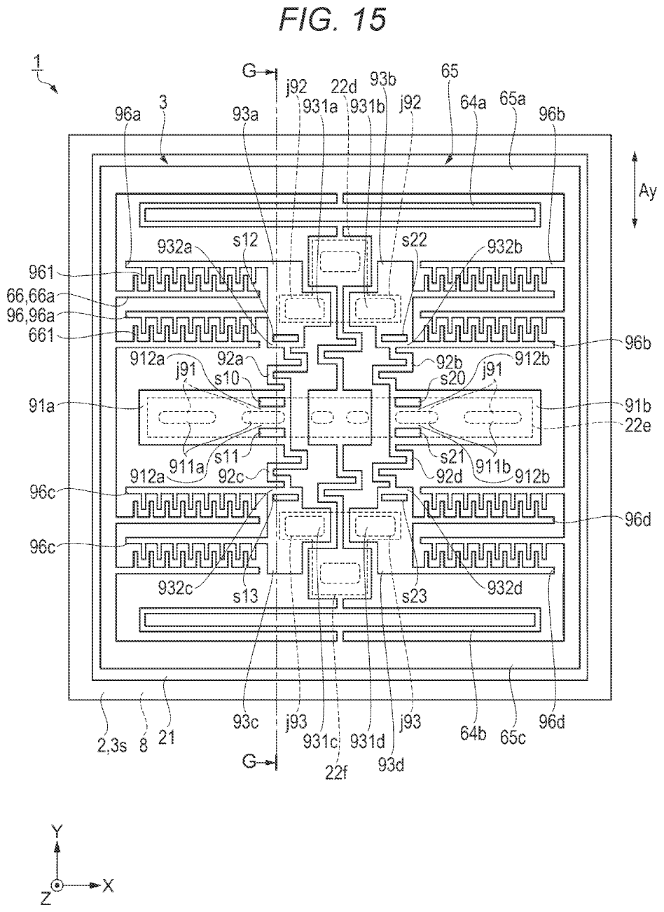

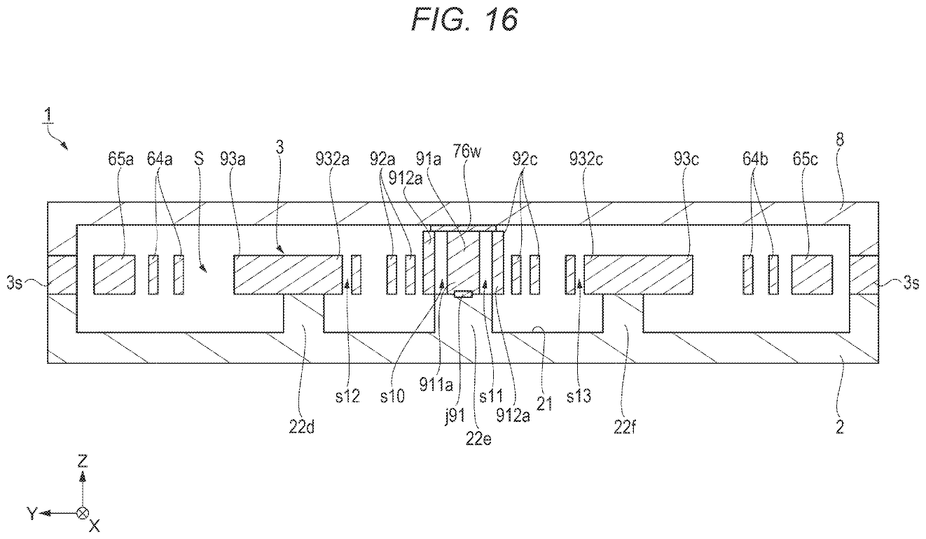

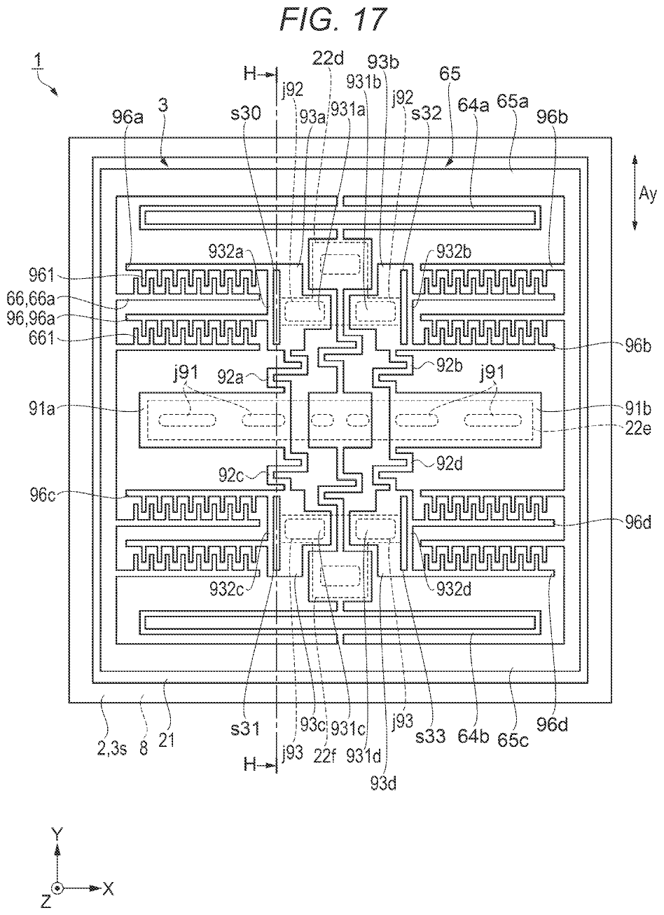

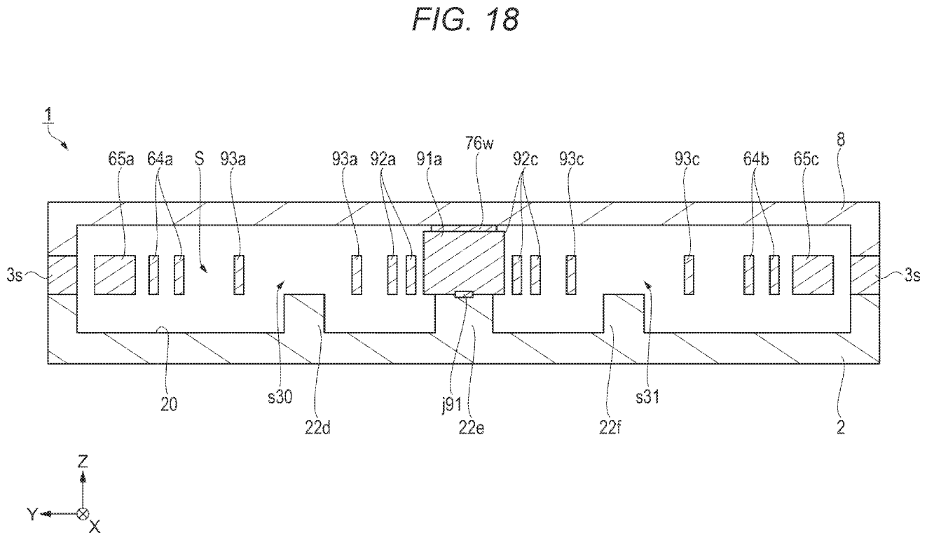

FIG. 13 is a plan view showing an inertial sensor according to Modification 1 of the embodiment. FIG. 14 is a cross-sectional view of the inertial sensor taken along a line F-F in FIG. 13. FIG. 15 is a plan view showing an inertial sensor according to Modification 2 of the embodiment. FIG. 16 is a cross-sectional view of the inertial sensor taken along a line G-G in FIG. 15. FIG. 17 is a plan view showing an inertial sensor according to Modification 3 of the embodiment. FIG. 18 is a cross-sectional view of the inertial sensor taken along a line H-H in FIG. 17. In the following description, differences from Embodiment 2 will be mainly described, and the same components as those in Embodiment 2 are denoted by the same reference signs and description thereof will be omitted.

### 2.4.1. Modification 1

As shown in FIG. 13, the inertial sensor 1 according to Modification 1 is different from the inertial sensor 1 according to Embodiment 2 in that slits s6 and s7 are formed in the conductor 61.

As shown in FIG. 14, the slits s6 and s7 are through holes penetrating the sensor element 3. The slits s6 and s7 are formed to reduce influence of stresses such as an external stress or a bonding stress.

As shown in FIG. 13, the slit s6 is formed in the second part 612 between the wiring 62a and the first part 611 in the conductor 61. In other words, the slit s6 is formed in a part of the conductor 61 that is not bonded to the mount 22e.

By forming the slit s6, the stress such as the external stress or the bonding stress transmitted to the movable part 65 through the bonding part j61, the lid 8, and the conductive member 85 can be reduced, and the acceleration Ay can be detected with higher accuracy.

The slit s7 is formed in the second part 612 between the wiring 62b and the first part 611 in the conductor 61. In other words, the slit s7 is formed in a part of the conductor 61 that is not bonded to the mount 22e.

By forming the slit s7, the stress such as the external stress or the bonding stress transmitted to the movable part 65 through the bonding part j61, the lid 8, and the conductive member 85 can be reduced, and the acceleration Ay can be detected with higher accuracy.

Modification 1 has the slits s4, s5, s6, and s7, and may be modified to a configuration having only the slits s6 and s7.

In addition, shapes of the slits s4, s5, s6, and s7 may be other than a square prism. For example, the shape may be a cylinder or a triangular prism. In addition, the number of each of the slits s4, s5, s6, and s7 may be plural, and the slits may be formed in a plurality of rows along the Y-axis direction.

In addition, the slits s4, s5, s6, and s7 are preferably through holes penetrating the sensor element 3, and may be grooves with a bottom when the slits have a function of reducing the stress such as the external stress or the bonding stress.

### 2.4.2. Modification 2

As shown in FIG. 15, the inertial sensor 1 according to Modification 2 is different from the inertial sensor 1 according to Embodiment 2 in that slits s10 and s11 are formed in the conductor 91a, slits s20 and s21 are formed in the conductor 91b, a slit s12 is formed in the supporter 93a, a slit s22 is formed in the supporter 93b, a slit s13 is formed in the supporter 93c, and a slit s23 is formed in the supporter 93d.

As shown in FIG. 16, the slits s10, s11, s12, and s13 are through holes penetrating the sensor element 3. Although not shown, the slits s20, s21, s22, and s23 are also through holes penetrating the sensor element 3. The slits s10, s11, s12, s13, s20, s21, s22, and s23 are formed to reduce influence of stresses such as an external stress or a bonding stress.

As shown in FIG. 15, the slit s10 is formed in the second part 912a between the wiring 92a and the first part 911a in the conductor 91a. In other words, the slit s10 is formed in a part of the conductor 91a that is not bonded to the mount 22e.

By forming the slit s10, the stress such as the external stress or the bonding stress transmitted to the fixed electrode 96a through the bonding part j91, the lid 8, and the conductive member 86 can be reduced, and the acceleration Ay can be detected with higher accuracy.

The slit s11 is formed in the second part 912a between the wiring 92c and the first part 911a in the conductor 91a. In other words, the slit s11 is formed in a part of the conductor 91a that is not bonded to the mount 22e.

By forming the slit s11, the stress such as the external stress or the bonding stress transmitted to the fixed electrode 96c through the bonding part j91, the lid 8, and the conductive member 86 can be reduced, and the acceleration Ay can be detected with higher accuracy.

The slit s12 is formed in the second part 932a between the wiring 92a and the first part 931a in the supporter 93a. In other words, the slit s12 is formed in a part of the supporter 93a that is not bonded to the mount 22d. In addition, it can be said that the slit s12 is formed in a part protruding from the mount 22d in the supporter 93a.

By forming the slit s12, the stress such as the external stress or the bonding stress transmitted to the fixed electrode 96a through the bonding part j92, the bonding part j91, the lid 8, and the conductive member 86 can be reduced, and the acceleration Ay can be detected with higher accuracy.

The slit s13 is formed in the second part 932c between the wiring 92c and the first part 931c in the supporter 93c. In other words, the slit s13 is formed in a part of the supporter 93c that is not bonded to the mount 22f. In addition, it can be said that the slit s13 is formed in a part protruding from the mount 22f in the supporter 93c.

By forming the slit s13, the stress such as the external stress or the bonding stress transmitted to the fixed electrode 96c through the bonding part j93, the bonding part j91, the lid 8, and the conductive member 86 can be reduced, and the acceleration Ay can be detected with higher accuracy.

The slit s20 is formed in the second part 912b between the wiring 92b and the first part 911b in the conductor 91b. In other words, the slit s20 is formed in a part of the conductor 91b that is not bonded to the mount 22e.

By forming the slit s20, the stress such as the external stress or the bonding stress transmitted to the fixed electrode 96b through the bonding part j91, the lid 8, and the conductive member 87 can be reduced, and the acceleration Ay can be detected with higher accuracy.

The slit s21 is formed in the second part 912b between the wiring 92d and the first part 911b in the conductor 91b. In other words, the slit s21 is formed in a part of the conductor 91b that is not bonded to the mount 22e.

By forming the slit s21, the stress such as the external stress or the bonding stress transmitted to the fixed electrode 96d through the bonding part j91, the lid 8, and the conductive member 87 can be reduced, and the acceleration Ay can be detected with higher accuracy.

The slit s22 is formed in the second part 932b between the wiring 92b and the first part 931b in the supporter 93b. In other words, the slit s22 is formed in a part of the supporter 93b that is not bonded to the mount 22d. In addition, it can be said that the slit s22 is formed in a part protruding from the mount 22d in the supporter 93b.

By forming the slit s22, the stress such as the external stress or the bonding stress transmitted to the fixed electrode 96b through the bonding part j92, the bonding part j91, the lid 8, and the conductive member 87 can be reduced, and the acceleration Ay can be detected with higher accuracy.

The slit s23 is formed in the second part 932d between the wiring 92d and the first part 931d in the supporter 93d. In other words, the slit s23 is formed in a part of the supporter 93d that is not bonded to the mount 22f. In addition, it can be said that the slit s23 is formed in a part protruding from the mount 22f in the supporter 93d.

By forming the slit s23, the stress such as the external stress or the bonding stress transmitted to the fixed electrode 96d through the bonding part j93, the bonding part j91, the lid 8, and the conductive member 87 can be reduced, and the acceleration Ay can be detected with higher accuracy.

Modification 2 has the slits s10, s11, s12, s13, s20, s21, s22, and s23, and may be modified to a configuration having only the slits s10, s11, s20, and s21. In addition, Modification 2 maybe modified to a configuration having only the slits s12, s13, s22, and s23. In addition, Modification 2 maybe modified to a configuration combined with Embodiment 2 or Modification 1.

In addition, the slits s10, s11, s12, s13, s20, s21, s22, and s23 may have a shape other than a square prism. For example, the shape may be a cylinder or a triangular prism. In addition, the number of each of the slits s10, s11, s12, s13, s20, s21, s22, and s23 may be plural, and the slits may be formed in a plurality of rows along the Y-axis direction.

In addition, the slits s10, s11, s12, s13, s20, s21, s22, and s23 are preferably through holes penetrating the sensor element 3, and may be grooves with a bottom when the slits have a function of reducing the stress such as the external stress or the bonding stress.

### 2.4.3. Modification 3

As shown in FIG. 17, the inertial sensor 1 according to Modification 3 is different from the inertial sensor 1 according to Embodiment 2 in that a slit s30 is formed in the supporter 93a, a slit s31 is formed in the supporter 93c, a slit s32 is formed in the supporter 93b, and a slit s33 is formed in the supporter 93d.

As shown in FIG. 18, the slits s30 and s31 are through holes penetrating the sensor element 3. Although not shown, the slits s32 and s33 are also through holes penetrating the sensor element 3. The slits s30, s31, s32, and s33 are formed to reduce influence of stresses such as an external stress or a bonding stress.

As shown in FIG. 17, the slit s30 is formed in the second part 932a between the fixed electrode 96a and the first part 931a in the supporter 93a. In other words, the slit s30 is formed in a part of the supporter 93a that is not bonded to the mount 22d. In addition, it can be said that the slit s30 is formed in a part protruding from the mount 22d in the supporter 93a.

By forming the slit s30, the stress such as the external stress or the bonding stress transmitted to the fixed electrode 96a through the bonding part j92, the bonding part j91, the lid 8, and the conductive member 86 can be reduced, and the acceleration Ay can be detected with higher accuracy.

The slit s31 is formed in the second part 932c between the fixed electrode 96c and the first part 931c in the supporter 93c. In other words, the slit s31 is formed in a part of the supporter 93c that is not bonded to the mount 22f. In addition, it can be said that the slit s31 is formed in a part protruding from the mount 22f in the supporter 93c.

By forming the slit s31, the stress such as the external stress or the bonding stress transmitted to the fixed electrode 96c through the bonding part j93, the bonding part j91, the lid 8, and the conductive member 86 can be reduced, and the acceleration Ay can be detected with higher accuracy.

The slit s32 is formed in the second part 932b between the fixed electrode 96b and the first part 931b in the supporter 93b. In other words, the slit s32 is formed in a part of the supporter 93b that is not bonded to the mount 22d. In addition, it can be said that the slit s32 is formed in a part protruding from the mount 22d in the supporter 93b.

By forming the slit s32, the stress such as the external stress or the bonding stress transmitted to the fixed electrode 96b through the bonding part j92, the bonding part j91, the lid 8, and the conductive member 87 can be reduced, and the acceleration Ay can be detected with higher accuracy.

The slit s33 is formed in the second part 932d between the fixed electrode 96d and the first part 931d in the supporter 93d. In other words, the slit s33 is formed in a part of the supporter 93d that is not bonded to the mount 22f. In addition, it can be said that the slit s33 is formed in a part protruding from the mount 22f in the supporter 93d.

By forming the slit s33, the stress such as the external stress or the bonding stress transmitted to the fixed electrode 96d through the bonding part j93, the bonding part j91, the lid 8, and the conductive member 87 can be reduced, and the acceleration Ay can be detected with higher accuracy.

The above-described Modification 3 maybe modified to a configuration combined with Embodiment 2, Modification 1, or Modification 2.

In addition, shapes of the slits s30, s31, s32, and s33 may be other than a square prism. For example, the shape may be a cylinder or a triangular prism. In addition, the number of each of the slits s30, s31, s32, and s33 may be plural, and the slits may be formed in a plurality of rows along the X-axis direction.

In addition, the slits s30, s31, s32, s33 are preferably through holes penetrating the sensor element 3, and may be grooves with a bottom when the slits have a function of reducing the stress such as the external stress or the bonding stress.

The above-described inertial sensor 1 is an acceleration sensor capable of detecting the acceleration Ay in the Y-axis direction, and the inertial sensor 1 according to the embodiment can also be applied to an acceleration sensor capable of detecting the acceleration in the X-axis direction. In addition, the inertial sensor 1 according to the embodiment can also be applied to an acceleration sensor capable of detecting an acceleration in the Z-axis direction. In addition, the inertial sensor 1 according to the embodiment can also be applied to an angular velocity sensor that detects an angular velocity.

As described above, according to the inertial sensor 1 in the embodiment, the following effects can be attained in addition to the effects of the above-described embodiment.

The inertial sensor 1 according to the embodiment includes the base 2 as a substrate provided with the mount 22e, the sensor element 3 bonded to the mount 22e, and the wiring 75w electrically coupled to the sensor element 3. The sensor element 3 includes the first part 611 of the conductor 61 as a first coupling part that is bonded to the mount 22e through the bonding part j61, the movable electrode 66a as a second coupling part including the electrode fingers 661, the second part 632a of the supporter 63a as a third coupling part that is provided between the first part 611 of the conductor 61 and the movable electrode 66a and that is wider than the movable electrode 66a. The second part 632a of the supporter 63a has the slit s4 as a through hole.

In this way, since the slit s4 is formed in the second part 632a of the supporter 63a wider than the movable electrode 66a, it is possible to reduce the influence of the stress transmitted through the bonding part j61, and it is possible to implement the inertial sensor 1 of high quality with little deterioration in detection accuracy.

In the inertial sensor 1 according to the embodiment, the second part 632a of the supporter 63a as the third coupling part has a plurality of slits s4 as through holes.

In this way, since there are the plurality of slits s4, the influence of the stress transmitted through the bonding part j61 can be dispersed and reduced by the plurality of slits s4, and it is possible to implement the inertial sensor 1 of high quality with little deterioration in detection accuracy.

The inertial sensor 1 according to the embodiment includes the base 2 as a substrate provided with the mount 22e, the sensor element 3 bonded to the mount 22e, and the wiring 75w electrically coupled to the sensor element 3. The sensor element 3 includes the first part 611 of the conductor 61 as a first coupling part that is bonded to the mount 22e through the bonding part j61, the movable electrode 66a as a second coupling part including the electrode fingers 661, the second part 632b of the supporter 63b as a third coupling part that is provided between the first part 611 of the conductor 61 and the movable electrode 66a and that is wider than the movable electrode 66a. The second part 632b of the supporter 63b has the slit s5 as a through hole.

In this way, since the slit s5 is formed in the second part 632b of the supporter 63b wider than the movable electrode 66a, it is possible to reduce the influence of the stress transmitted through the bonding part j61, and it is possible to implement the inertial sensor 1 of high quality with little deterioration in detection accuracy.

The inertial sensor 1 according to the embodiment includes the base 2 as a substrate provided with the mount 22e, the sensor element 3 bonded to the mount 22e, and the wiring 75w electrically coupled to the sensor element 3. The sensor element 3 includes the first part 611 of the conductor 61 as a first coupling part that is bonded to the mount 22e through the bonding part j61, the wiring 62a as a second coupling part including the electrode fingers 661, the second part 612 of the conductor 61 as a third coupling part that is provided between the first part 611 of the conductor 61 and the wiring 62a and that is wider than the wiring 62a. The second part 612 of the conductor 61 has the slit s6 as a through hole.

In this way, since the slit s6 is formed in the second part 612 of the conductor 61 wider than the wiring 62a, it is possible to reduce the influence of the stress transmitted through the bonding part j61, and it is possible to implement the inertial sensor 1 of high quality with little deterioration in detection accuracy.

In the inertial sensor 1 according to the embodiment, the second part 612 of the conductor 61 serving as the third coupling part has a plurality of slits s6 as through holes.

In this way, since there are the plurality of slits s6, the influence of the stress transmitted through the bonding part j61 can be dispersed and reduced by the plurality of slits s6, and it is possible to implement the inertial sensor 1 of high quality with little deterioration in detection accuracy.

In the inertial sensor 1 according to the embodiment, the second part 612 of the conductor 61 serving as the third coupling part overlaps the mount 22e in a plan view, and the second part 612 of the conductor 61 does not overlap the bonding part j61 in a plan view.

In this way, the second part 612 of the conductor 61 is not bonded to the mount 22e in a plan view. In other words, the slit s6 formed in the second part 612 of the conductor 61 is not bonded to the mount 22e. Therefore, it is possible to reduce the influence of the stress transmitted through the bonding part j61, and it is possible to implement the inertial sensor 1 of high quality with little deterioration in detection accuracy.

The inertial sensor 1 according to the embodiment includes the base 2 as a substrate provided with the mount 22e, the sensor element 3 bonded to the mount 22e, and the wiring 75w electrically coupled to the sensor element 3. The sensor element 3 includes the first part 611 of the conductor 61 as a first coupling part that is bonded to the mount 22e through the bonding part j61, the wiring 62b as a second coupling part including the electrode fingers 661, the second part 612 of the conductor 61 as a third coupling part that is provided between the first part 611 of the conductor 61 and the wiring 62b and that is wider than the wiring 62b. The second part 612 of the conductor 61 has the slit s7 as a through hole.

In this way, since the slit s7 is formed in the second part 612 of the conductor 61 wider than the wiring 62b, it is possible to reduce the influence of the stress transmitted through the bonding part j61, and it is possible to implement the inertial sensor 1 of high quality with little deterioration in detection accuracy.

The inertial sensor 1 according to the embodiment includes the base 2 as a substrate provided with the mount 22e, the sensor element 3 bonded to the mount 22e, and the wiring 76w electrically coupled to the sensor element 3. The sensor element 3 includes the first part 911a of the conductor 91a as a first coupling part that is bonded to the mount 22e through the bonding part j91, the fixed electrode 96 as a second coupling part including the electrode fingers 961, the second part 932a of the supporter 93a as a third coupling part that is provided between the first part 911a of the conductor 91a and the fixed electrode 96 and that is wider than the fixed electrode 96. The second part 932a of the supporter 93a has the slit s12 as a through hole.

In this way, since the slit s12 is formed in the second part 932a of the supporter 93a wider than the fixed electrode 96, it is possible to reduce the influence of the stress transmitted through the bonding part j91, and it is possible to implement the inertial sensor 1 of high quality with little deterioration in detection accuracy.

The inertial sensor 1 according to the embodiment includes the base 2 as a substrate provided with the mount 22e, the sensor element 3 bonded to the mount 22e, and the wiring 76w electrically coupled to the sensor element 3. The sensor element 3 includes the first part 911a of the conductor 91a as a first coupling part that is bonded to the mount 22e through the bonding part j91, the wiring 92a as a second coupling part including the electrode fingers 961, the second part 912a of the conductor 91a as a third coupling part that is provided between the first part 911a of the conductor 91a and the wiring 92a and that is wider than the wiring 92a. The second part 912a of the conductor 91a has the slit s10 as a through hole.

In this way, since the slit s10 is formed in the second part 912a of the conductor 91a wider than the wiring 92a, it is possible to reduce the influence of the stress transmitted through the bonding part j91, and it is possible to implement the inertial sensor 1 of high quality with little deterioration in detection accuracy.

The inertial sensor 1 according to the embodiment includes the base 2 as a substrate provided with the mount 22d, the sensor element 3 bonded to the mount 22d, and the wiring 76w electrically coupled to the sensor element 3. The sensor element 3 includes the first part 931a of the supporter 93a as a first coupling part that is bonded to the mount 22d through the bonding part j92, the fixed electrode 96 as a second coupling part including the electrode fingers 961, the second part 932a of the supporter 93a as a third coupling part that is provided between the first part 931a of the supporter 93a and the fixed electrode 96 and that is wider than the fixed electrode 96. The second part 932a of the supporter 93a has the slit s30 as a through hole.

In this way, since the slit s30 is formed in the second part 932a of the supporter 93a wider than the fixed electrode 96, it is possible to reduce the influence of the stress transmitted through the bonding part j92, and it is possible to implement the inertial sensor 1 of high quality with little deterioration in detection accuracy.

The inertial sensor 1 according to the embodiment includes the base 2 as a substrate including the mount 22e as a first mount and the mount 22d as a second mount, the sensor element 3 bonded to the mount 22e and the mount 22d, and the wiring 75w electrically coupled to the sensor element 3. The sensor element 3 includes the first part 611 of the conductor 61 as a first coupling part that is bonded to the mount 22e through the bonding part j61 as a first bonding part, the movable electrode 66a as a second coupling part including the electrode fingers 661, the second part 632a of the supporter 63a as a third coupling part that is provided between the first part 611 of the conductor 61 and the movable electrode 66a and that is wider than the movable electrode 66a, and the second part 612 of the conductor 61 as a fourth coupling part that is provided between the first part 611 of the conductor 61 and the movable electrode 66a and that is wider than the movable electrode 66a. The second part 632a of the supporter 63a has the slit s4 as a first through hole, and the second part 612 of the conductor 61 has the slit s6 as a second through hole.

In this way, since the slit s4 is formed in the second part 632a of the supporter 63a wider than the movable electrode 66a, and the slit s6 is formed in the second part 612 of the conductor 61 wider than the movable electrode 66a, it is possible to reduce the influence of the stress transmitted through the bonding part j61, and it is possible to implement the inertial sensor 1 of high quality with little deterioration in detection accuracy.

The inertial sensor 1 according to the embodiment includes the base 2 as a substrate including the mount 22e as a first mount and the mount 22d as a second mount, the sensor element 3 bonded to the mount 22e and the mount 22d, and the wiring 76w electrically coupled to the sensor element 3. The sensor element 3 includes the first part 911a of the conductor 91a as a first coupling part that is bonded to the mount 22e through the bonding part j91 serving as a first bonding part, the fixed electrode 96 as a second coupling part including the electrode fingers 961, the second part 932a of the supporter 93a as a third coupling part that is provided between the first part 911a of the conductor 91a and the fixed electrode 96 and that is wider than the fixed electrode 96, and the second part 912a of the conductor 91a as a fourth coupling part that is provided between the first part 911a of the conductor 91a and the fixed electrode 96 and that is wider than the fixed electrode 96. The second part 932a of the supporter 93a has the slit s12 as a first through hole, and the second part 912a of the conductor 91a has the slit s10 as a second through hole.

In this way, since the slit s12 is formed in the second part 932a of the supporter 93a wider than the fixed electrode 96, and the slit s10 is formed in the second part 912a of the conductor 91a wider than the fixed electrode 96, it is possible to reduce the influence of the stress transmitted through the bonding part j91, and it is possible to implement the inertial sensor 1 of high quality with little deterioration in detection accuracy.

### 3. Embodiment 3

### 3.1. Overview of Inertial Measurement Unit

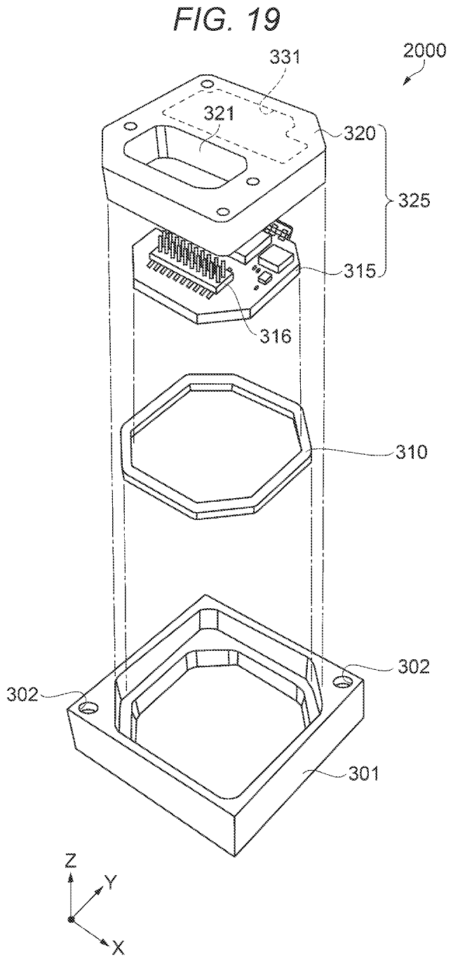

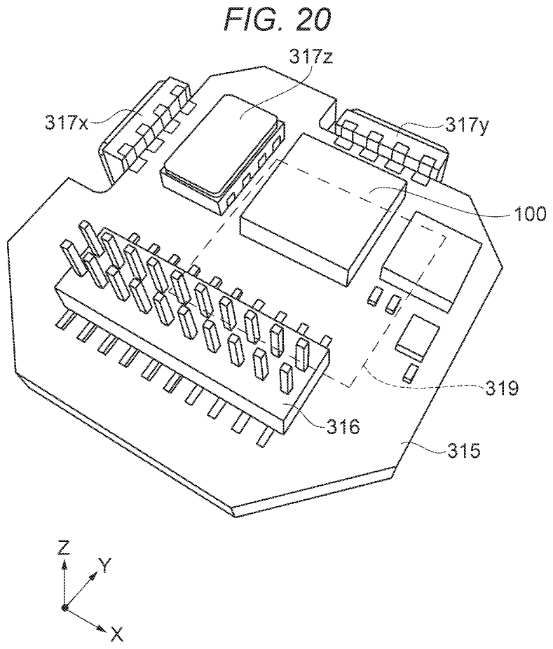

Next, an inertial measurement unit 2000 including the inertial sensor 1 will be described with reference to FIGS. 19 and 20.

FIG. 19 is an exploded perspective view showing a schematic configuration of an inertial measurement unit (IMU) according to the embodiment. FIG. 20 is a perspective view of a substrate mounted on the inertial measurement unit and on which the inertial sensor is mounted.

The inertial measurement unit 2000 is mounted on a device to be mounted such as an automatic vehicle, a robot, a smartphone, or a portable activity meter, and is used as a device that detects a posture, a behavior, or the like of the device to be mounted.

As shown in FIG. 19, the inertial measurement unit 2000 includes an outer case 301, a bonding member 310, and a sensor module 325. The sensor module 325 is fitted or inserted into the outer case 301 with the bonding member 310 interposed therebetween.

The outer case 301 is a box-shaped container having a rectangular outer shape without a lid, and an inside thereof is an internal space surrounded by a wall. A material of the outer case 301 is, for example, aluminum. Other metals such as zinc and stainless steel, resins, and composite materials of metals and resins may be used.

Through holes 302 are formed near two vertices located in a diagonal line direction on an upper surface of the outer case 301. The through hole 302 is used when attaching the inertial measurement unit 2000 to the device to be mounted.

The sensor module 325 includes an inner case 320 and a circuit board 315.

The inner case 320 is a member that supports the circuit board 315, and has a shape that is accommodated inside the outer case 301. A material of the inner case 320 may be the same as that of the outer case 301.

A recess 331 for preventing contact with the circuit board 315 and an opening 321 for exposing a connector 316 are formed in a lower surface of the inner case 320.

A configuration of the circuit board 315 on which the inertial sensor 1 is mounted will be described with reference to FIG. 20.

As shown in FIG. 20, the circuit board 315 is a multilayer board in which a plurality of through holes are formed, and a glass epoxy board is used. The circuit board is not limited to the glass epoxy board. For example, a rigid substrate such as a composite substrate or a ceramic substrate may be used.

The connector 316, an acceleration detection unit 100, angular velocity sensors 317x, 317y, 317z, and the like are mounted on an upper surface and side surfaces of the circuit board 315.

The acceleration detection unit 100 is mounted with the inertial sensor 1 and is an acceleration sensor for measuring an acceleration in the Z-axis direction.

The connector 316 is a plug-type connector and includes two rows of coupling terminals disposed at equal pitches in the X-axis direction. In the embodiment, there are two rows of coupling terminals with 10 pins and 20 pins in total, and the number of coupling terminals may be changed as appropriate depending on design specifications.

The angular velocity sensor 317z is a gyro sensor that detects an angular velocity of one axis in the Z-axis direction. As a preferred example, quartz crystal is used as a vibrator, and a vibrating gyro sensor that detects an angular velocity from a Coriolis force applied to a vibrating object is used. The sensor is not limited to the vibrating gyro sensor, and a sensor using ceramic or silicon may be used as the vibrator.

The angular velocity sensor 317x that detects an angular velocity of one axis in the X-axis direction is mounted on the side surface of the circuit board 315 in the X-axis direction such that a mounting surface is orthogonal to the X axis. Similarly, the angular velocity sensor 317y that detects an angular velocity of one axis in the Y-axis direction is mounted on the side surface of the circuit board 315 in the Y-axis direction such that the mounting surface is orthogonal to the Y axis.

The angular velocity sensors 317x, 317y, and 317z are not limited to the configuration using three angular velocity sensors each for a respective one of the X axis, the Y axis, and the Z axis, and any sensor that can detect the angular velocities in three axes may be used. For example, a sensor device that can detect the angular velocities in three axes in one device or package may be used.

The acceleration detection unit 100 is an acceleration sensor that measures an acceleration in the Z-axis direction, and may measure an acceleration in the X-axis direction or the Y-axis direction. In addition, a plurality of inertial sensors 1 maybe mounted to detect the acceleration in two axial directions, for example, the Z-axis direction and the Y-axis direction, the Z-axis direction and the X-axis direction, or three axial directions, that is, the X-axis direction, the Y-axis direction, and the Z-axis direction.

A control IC 319 serving as a controller is mounted on the lower surface of the circuit board 315.

The control IC 319 is a micro controller unit (MCU), incorporates a storage including a nonvolatile memory, an A/D converter, and the like, and controls each unit of the inertial measurement unit 2000. The storage stores a program in which an order and contents for detecting an acceleration and an angular velocity are defined, a program in which detection data is digitized and incorporated into packet data, accompanying data, and the like. In addition, a plurality of electronic components are mounted on the circuit board 315.

According to the inertial measurement unit 2000, since the acceleration detection unit 100 including the inertial sensor 1 is used, it is possible to provide the inertial measurement unit 2000 having excellent impact resistance and improved reliability.

As described above, according to the inertial measurement unit 2000 including the inertial sensor 1 in the embodiment, in addition to the effects of Embodiments 1 and 2, it is possible to provide a highly reliable inertial measurement unit in which the influence of the stress is reduced.

Although preferred embodiments have been described above, the present disclosure is not limited to the above-described embodiments. In addition, the configuration of each unit according to the present disclosure can be replaced with any configuration that exhibits the same function as that of the above-described embodiments, and any configuration can be added.

What is claimed is:

1. An inertial sensor comprising:
a substrate provided with a mount;
a sensor element bonded to the mount; and
a wiring electrically coupled to the sensor element, wherein
the sensor element includes
a first coupling part that is bonded to the mount through a bonding part,
a second coupling part including electrode fingers, and
a third coupling part that is provided between the first coupling part and the second coupling part and that is wider than the second coupling part, and
the third coupling part is formed with a through hole.

2. The inertial sensor according to claim 1, wherein
the third coupling part is formed with a plurality of through holes.

3. The inertial sensor according to claim 1, wherein
the through hole does not overlap the mount in a plan view.

4. The inertial sensor according to claim 1, wherein
the third coupling part overlaps the mount in a plan view, and
the third coupling part does not overlap the bonding part in the plan view.

5. An inertial sensor comprising:
a substrate including a first mount and a second mount;
a sensor element bonded to the first mount and the second mount; and
a wiring electrically coupled to the sensor element, wherein
the sensor element includes
a first coupling part that is bonded to the first mount through a first bonding part,
a second coupling part including electrode fingers,
a third coupling part that is provided between the first coupling part and the second coupling part and that is wider than the second coupling part, and
a fourth coupling part that is provided between the first coupling part and the second coupling part and that is wider than the second coupling part,
the third coupling part is formed with a first through hole, and
the fourth coupling part is formed with a second through hole.

6. An inertial measurement unit comprising:
the inertial sensor according to claim 1.
